(19) United States
(12) Patent Application Publication
(10) Pub. No.: US 2025/0059387 A1
(43) Pub. Date: Feb. 20, 2025

(54) ORGANIC COLORANTS, INCLUDING PIGMENTS AND DYES, FOR PLASTICS, INKS, PAINTS, COATINGS, AND OTHER APPLICATIONS

(71) Applicant: Kebotix, Inc, Cambridge, MA (US)

(72) Inventors: Semion Saykin, Arlington, MA (US); Victoria Campbell, Somerville, MA (US); Selma Duhovic, Denver, CO (US); David Lee Wheeler, Brighton, MA (US); Kevin Ryan, Watertown, MA (US); Sreeletha Joby Eldo, Andover, MA (US); Nathan Darrell Peterson Ricke, Medford, MA (US); Zhongwei Hu, Newton Upper Falls, MA (US); Dennis Sheberla, Bedford, MA (US); Jhaylen McDavid, Cambridge, MA (US); Tanja Dimitrov, Brooklyn, NY (US); Bruce Mulholland, Verona, KY (US); Zachary Xavier Giustra, North Andover, MA (US); Grit Kupgan, Atlanta, GA (US)

(73) Assignee: Kebotox, Inc., Cambridge, MA (US)

(21) Appl. No.: 18/722,068

(22) PCT Filed: Dec. 20, 2022
(86) PCT No.: PCT/US2022/053523

§ 371 Date: Jun. 20, 2024

Related U.S. Application Data
(60) Provisional application No. 63/296,554, filed on Jan. 5, 2022.

(51) Int. Cl. C09D 7/41; C08K 5/3465; C08K 5/45; C08K 5/56; C09D 11/037; C09D 17/00

(52) U.S. Cl. CPC C09D 7/41; C08K 5/3465; C08K 5/45; C08K 5/56; C09D 11/037; C09D 17/00

(57) ABSTRACT

The present disclosure generally relates to optical molecules, including but not limited to 1,3-thiazolidin-4-ones and other molecules comprising an aza-heterocyclic ring system containing a chalcogen. In some embodiments, the molecules may absorb light between 300 nm and 800 nm, e.g., appearing as various colors, depending on the absorbance. In some cases, the optical molecules can be used as color additives, pigments, dyes, or the like. Other embodiments of the disclosure are generally directed to systems and devices using such compounds, methods of using such compounds, kits involving such compounds, or the like.

### RELATED APPLICATIONS

This application claims the benefit of U.S. Provisional Patent Application Ser. No. 63/296,554, filed Jan. 5, 2022, entitled “Organic Colorants, Including Pigments and Dyes, for Plastics, Inks, Paints, Coatings, And Other Applications,” incorporated herein by reference in its entirety.

### FIELD

The present disclosure generally relates to optical molecules, including but not limited to 1,3-thiazolidin-4-ones and other molecules comprising an aza-hetreocyclic ring system containing a chalcogen. In some cases, the optical molecules can be used as color additives.

### BACKGROUND

Colors within certain additives, such as pigments and dyes, typically arise because such additives preferentially absorb certain wavelengths of visible light, which producing the appearance of colors. Although various color additives have been known since antiquity (e.g., ochre is a brownish color made from a mixture of rust, clay, and sand), humans are drawn to colors, and there is always a desire for more colors and color additives, e.g., for use in different applications.

### SUMMARY

The present disclosure generally relates to optical molecules, including but not limited to 1,3-thiazolidin-4-ones and other molecules comprising an aza-heterocyclic ring system containing a chalcogen. In some cases, the optical molecules can be used as color additives. For example, in certain embodiments, the optical molecules can be used as pigments and/or dyes, for example, in plastic, ink, or paint formulations. Such optical molecules can be used in various applications such as packaging, medical and healthcare, consumer products, wire and cable, lawn and garden tool appliances, building and construction, recreation and leisure, automotive, etc.

The subject matter of the present disclosure involves, in some cases, interrelated products, alternative solutions to a particular problem, and/or a plurality of different uses of one or more systems and/or articles.

One aspect is generally drawn to a colorant for use in coloring a material, comprising a 1,3-thiazolidin-4-one. Another aspect is generally drawn to a colorant for use in coloring a material, comprising an aza-heterocyclic ring system containing a chalcogen.

Another aspect is generally drawn to a method comprising coating the surface of an article with a colorant comprising a 1,3-thiazolidin-4-one. Still another aspect is generally drawn to a method comprising coating the surface of an article with a colorant comprising an aza-heterocyclic ring system containing a chalcogen. Yet another aspect is generally drawn to a method comprising embedding a colorant comprising a 1,3-thiazolidin-4-one in an article. In another aspect, the method comprises embedding a colorant comprising an aza-heterocyclic ring system containing a chalcogen in an article.

In another aspect, the present disclosure encompasses methods of making one or more of the embodiments described herein, such as thiazoles or other aza-heterocyclic ring systems. In still another aspect, the present disclosure encompasses methods of using one or more of the embodiments described herein, such as thiazoles or other aza-heterocyclic ring systems.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every FIGURE, nor is every component of each embodiment of the disclosure shown where illustration is not necessary to allow those of ordinary skill in the art to understand the disclosure. In the figures:

FIGS. 1-13 illustrate certain additional compounds, in accordance with other embodiments.

### DETAILED DESCRIPTION

The present disclosure generally relates to optical molecules, including but not limited to 1,3-thiazolidin-4-ones and other molecules comprising an aza-heterocyclic ring system containing a chalcogen. In some embodiments, the molecules may absorb light between 300 nm and 800 nm, e.g., appearing as various colors, depending on the absorbance. In some cases, the optical molecules can be used as color additives, pigments, dyes, or the like. Other embodiments of the disclosure are generally directed to systems and devices using such compounds, methods of using such compounds, kits involving such compounds, or the like.

In certain embodiments, optical molecules such as those described herein may be used as color additives (e.g., pigments, dyes, etc.) in applications such as plastic, ink, or paint formulations, etc. Such formulations can be used in markets ranging from packaging, medical and healthcare, consumer products, wire and cable, lawn and garden tool appliances, building and construction, recreation and leisure, automotive, etc. In addition, in some cases, molecules such as those described herein may be used, e.g., as color additives in applications such as masterbatch and plastic formulations (e.g., commodity, engineering, and high-performance resins), including, but not limited to, polymers (including plastics, polymer resins, melts, etc.) such as ethylene vinyl acetate (EVA), polyvinyl chloride (PVC), acrylonitrile butadiene styrene (ABS), polycarbonate (PC), styrene acrylonitrile (SAN), low-density polyethylene (LDPE), high-density polyethylene (HDPE), polypropylene (PP), polymethyl methacrylate (PMMA), polyoxymethylene (POM), polybutylene terephthalate (PBT), polyamide (PA), polystyrene (PS), polyethylene terephthalate (PET), polyphenylene sulfide (PPS), liquid crystal polymer (LCP), polyphthalamide (PPA), polyether ether ketone (PEEK), polysulfone (PSU), polyether ketone (PEK), thermoplastic pulyurethane (TPU), thermoplastic vulcanizates (TPV), thermoplastic polyolefins (TPO), thermoplastic elastomers (TPE), styrene butadiene block copolymer (SBC), ethylene methacrylic acid (EMAA), polyamide-imides (PAI), polyetherimide (PEI), polytetrafluoroethylene (PTFE), polyimides (PI), polyethersulfone (PES), polyaryletherketone (PAEK), polyphenylene sulfide (PPS), etc.; ink and printing paste formulations; paint, coating, and lacquer formulations; and the like.

For example, in one set of embodiments, a colorant may be applied to the surface of an article, e.g., coated or painted on the surface. Non-limiting examples of colorants include pigments and dyes. A pigment may be a colorant that is generally insoluble in a medium (e.g., a solvent or polymer matrix, etc.), and may remain as a tiny particle. Such particles can be readily observed using microscopy or other techniques known to those of ordinary skill in the art. In contrast, a dye may be a colorant that dissolves in a medium.

In some embodiments, a colorant may be applied to a masterbatch formulation or compound. In yet another embodiment, a colorant may be applied as a component in ink or paste. In some embodiments, the colorant may be embedded in an article, e.g., during or after formation of the article. The colorant may include a color additive, such as a pigment or a dye, including any of those described herein. The colorant may be, for example, present in a paint, an ink, or a dye. In some cases, the colorant may be aqueous and/or water soluble (e.g., as in a water-based ink or a water-based paint, etc.). In certain embodiments, however, the colorant may not be aqueous and/or water soluble (e.g., as in an oil-based ink or an oil-based paint, etc.). The colorant may comprise solvents such as water, turpentine, acetone, naphtha, toluene, methyl ethyl ketone (MEK), dimethylformamide (DMF), glycol ether, xylene, etc. In some cases, the colorant may be present in an emulsion. In some cases, the colorant may be dissolved within a solvent, although in certain embodiments, the colorant may not be dissolved within a solvent. Those of ordinary skill in the art will be familiar with common colorant formulations, e.g., for paints, inks, dyes, and the like.

Certain aspects are generally directed to molecules comprising an aza-heterocyclic ring system containing a chalcogen, for example, thiazolidinones such as 1,3-thiazolidin-4-ones, or other structures such as oxazolidinones (e.g., 1,3-oxazolidin-4-ones) or selenazolidinones (e.g., 1,3-selenazolidin-4-ones). 1,3-thiazolidin-4-ones and other molecules comprising an aza-heterocyclic ring system containing a chalcogen have not generally been identified as being suitable for color additives, pigments, dyes, or the like. However, it has been found that certain types of 1,3-thiazolidin-4-ones and other molecules comprising an aza-heterocyclic ring system containing a chalcogen are able to absorb light in the visible light range, e.g., between 300 nm and 800 nm. Such 1,3-thiazolidin-4-ones and other molecules comprising an aza-heterocyclic ring system containing a chalcogen may appear as various colors, depending on the absorbance.

In one set of embodiments, a 1,3-thiazolidin-4-one may have a structure:

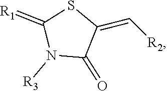

In addition, certain embodiments are directed to aza-heterocyclic ring systems containing chalcogens with a general structure represented by:

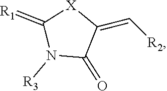

In these structures, X may be a chalcogen such as O, S, or Se, and R₂ may be a moiety conjugated to the structure, e.g., by pi (π) bonds. For example, R₂ may include a system of alternating single and double bonds to produce a structure that is conjugated with the 1,3-thiazolidin-4-one portion. R₂ in some embodiments may independently be —H or a conjugated group, such as aryl, for example, phenyl, naphthyl, phenanthrenes, heteroaryls (e.g., furans, thiophenes, pyrroles, pyrazoles, imidazoles, oxazoles, thiazoles, oxadiazoles, pyridines, pyrimidines, etc.), or benzo-fused heteroaromatics (e.g., benzofurans, benzimidazoles, benzoxazoles, benzothioazoles), etc. In some embodiments, these aromatic or hetero aromatic groups may have one or more substituents, which may independently be —H, an alkyl (such as methyl, ethyl, propyl, butyl, isopropyl, isobutyl, tert-butyl, or the like), a cycloalkyl (e.g., cyclopropyl, cyclobutyl, cyclopentyl, cyclohexyl, etc.), an aromatic (such as phenyl, naphthyl, anthracene, fluorenyl, or the like), a heterocyclic (such as an epoxide, furyl, pyrrolyl, thiazolyl, oxazolyl, an imidazolyl, pyridyl, pyrazinyl, pyrimidinyl, piperidinyl, pyrazolyl, etc.), a vinyl group or a propargyl group, a hydroxyl, an alkoxy (such as methoxy, ethoxy, propoxy, butoxy, phenoxy, a phenylmethoxy, a phenylethoxy, etc.), or an amine, e.g., —NH₂, an alkylamine (such as methyl amine, ethyl amine propyl amine, or the like), a dialkylamine (such as dimethyl amine, diisopropyl amine, etc.), an arylamine (such as phenyl amine, naphthyl amine etc.), a diarylamine (such as diphenyl amine or the like), an amide such as —CONH₂ or —CONHR (where R is an alkyl or aryl group),, an N-substituted amide (e.g., where the substituent is an alkyl, an aryl, a carboxylic acid, an alkoxy carbonyl such as methoxy carbonyl, ethoxy carbonyl, phenoxy carbonyl, etc.), an alkyl sulfonyl (such as methyl sulfonyl, ethyl sulfonyl, p-tolyl sulfonyl, cyclohexyl sulfonyl, etc.), a ketone (such as methyl ketone, ethyl ketone, phenyl ketone, etc.), sulfonamide, nitrile, nitro, or the like.

As another example, R₂ may have a structure like a coumarin as shown below,

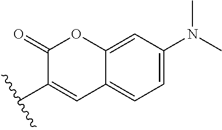 [SMILES: *c1cc2ccc(N(C)C)cc2oc1=O]

As yet another example, R₂ may be connected to the thiazolidine through one double bond or multiple conjugated double bonds, for example as shown below:

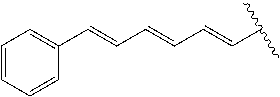 [SMILES: */C=C/C=C/C=C/c1ccccc1]

In some embodiments, the double bond may result in E and/or Z isomers.

In addition, in some cases, R₁ and R₃ may be connected to form a 5- or 6-member ring, e.g., as shown by (in the following:

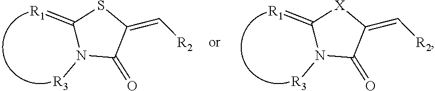

where X may be a chalcogen such as O, S, or Se. In addition, in some embodiments, the (ring structure may be conjugated with the 1,3-thiazolidin-4-one portion, e.g., by including a system of alternating single and double bonds. In some cases, such conjugated structures may give rise to colors, e.g., such that such compounds can be used as color additives, pigments, dyes, etc. In some cases, the conjugated systems may be caused by the delocalization of pi (π) electrons over part or all of the molecule, e.g., such that at least a portion of the molecule exhibits a conjugated system of p orbitals due to the pi electrons.

As a non-limiting example, in one set of embodiments, the 1,3-thiazolidin-4-one may have a structure such as:

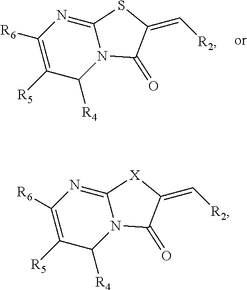

where X may be a chalcogen such as O, S, or Se, and the (forms a 6-member pyrimidine ring. In some cases, R₄, R₅, and R₆ may independently be —H or be selected from an alkyl (such as a methyl group, an ethyl group, a propyl group, a butyl group, an isopropyl group, an isobutyl group, a tert-butyl group, or the like), a cycloalkyl (such as a cyclopropyl group, a cyclobutyl group or a cyclopentyl group, a cyclohexyl group, etc. or the like), an aromatic (such as phenyl group, a naphthyl group, an anthracene group, a fluorenyl group, or the like), a heterocyclic (such as an epoxide group, a furyl group, a pyrrolyl group, a thiazolyl group, an oxazolyl group, an imidazolyl group, a pyridyl group, a pyrazinyl group, a pyrimidinyl group, a piperidinyl group, a pyrazolyl group, etc.), a vinyl group or a propargyl group, a hydroxyl, an alkoxy (such as methoxy, ethoxy, propoxy, butoxy, phenoxy, a phenylmethoxy, a phenylethoxy, or similar), an amide such as —CONH₂ or —CONHR (where R is an alkyl or aryl group), an alkylamine (such as methyl amine, ethyl amine propyl amine or the like), a dialkylamine (such as dimethyl amine, diisopropyl amine, etc.) an arylamine (such as phenyl amine, naphthyl amine etc.), a diarylamine (such as diphenyl amine or the like), an amide such as —CONH₂, an N-substituted amide (where substituent is an alkyl or an aryl group or carboxylic acid or an alkoxy carbonyl group, such as a methoxy carbonyl group, an ethoxy carbonyl group, a phenoxy carbonyl etc.), an alkyl sulfonyl (such as a methyl sulfonyl group, an ethyl sulfonyl group, a p-tolyl sulfonyl group, a cyclohexyl sulfonyl group, etc.), a ketone (such as methyl ketone, an ethyl ketone or a phenyl ketone, etc.), a sulfonamide, a nitrile, a nitro, a halogen (for example, F, Cl, Br or I), an alkylhalo group (such as a trifluoromethyl, a trichloromethyl, a tribromomethyl, etc.), an acyl, or the like.

In some embodiments, R₄, R₅, and R₆ may each independently include one or more aromatic or heteroaromatic groups. These groups may each independently one or more substituents, which may be all —H or be selected from alkyl (such as a methyl group, an ethyl group, a propyl group, a butyl group, an isopropyl group, an isobutyl group, a tert-butyl group, or the like), a cycloalkyl (such as a cyclopropyl group, a cyclobutyl group or a cyclopentyl group, a cyclohexyl group, etc. or the like), an aromatic (such as phenyl group, a naphthyl group, an anthracene group, a fluorenyl group, or the like), a heterocyclic (such as an epoxide group, a furyl group, a pyrrolyl group, a thiazolyl group, an oxazolyl group, an imidazolyl group, a pyridyl group, a pyrazinyl group, a pyrimidinyl group, a piperidinyl group, a pyrazolyl group, etc.), a vinyl group or a propargyl group, a hydroxyl, an alkoxy (such as methoxy, ethoxy, propoxy, butoxy, phenoxy, a phenylmethoxy, a phenylethoxy, or similar), an amine such as —NH₂, an alkylamine (such as methyl amine, ethyl amine propyl amine or the like), a dialkylamine (such as dimethyl amine, diisopropyl amine, etc.) an arylamine (such as phenyl amine, naphthyl amine etc.), a diarylamine (such as diphenyl amine or the like), an amide such as —CONH₂ or —CONHR (where R is an alkyl or aryl group),, an N-substituted amide (where substituent is an alkyl or an aryl group or carboxylic acid or an alkoxy carbonyl group, such as a methoxy carbonyl group, an ethoxy carbonyl group, a phenoxy carbonyl etc.), an alkyl sulfonyl (such as a methyl sulfonyl group, an ethyl sulfonyl group, a p-tolyl sulfonyl group, a cyclohexyl sulfonyl group, etc.), a ketone (such as methyl ketone, an ethyl ketone or a phenyl ketone, etc.), a sulfonamide, a nitrile, a nitro, a halogen (for example, F, Cl, Br or I), an alkylhalo group (such as a trifluoromethyl, a trichloromethyl, a tribromomethyl, etc.), an acyl, or the like.

In addition, in some cases, R₅ may connect with R₄ or R₆ to form a ring, e.g., a 5- or 6-member ring. For example, in one set of embodiments, R₅ and R₆ can be linked to form the following:

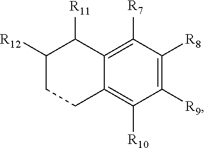

where R₇, R₈, R₉, R₁₀, R₁₁ and R₁₂ may independently be —H or be selected from an alkyl (such as a methyl group, an ethyl group, a propyl group, a butyl group, an isopropyl group, an isobutyl group, a tert-butyl group, or the like), or an aryl group, (such as phenyl, naphthyl, anthracenyl, phenanthryl etc.), heteroaryls (e.g., furans, thiophenes, pyrrole, pyrazoles, imidazoles, oxazoles, thiazoles, oxadiazoles, pyridines, pyrimidines, etc.), or benzo-fused heteroaromatics (e.g., benzofurans, benzimidazoles, benzoxazoles, benzothioazoles), an amino, an alkylamino, an aminophenyl, a diphenyl amino, —NHCOR (R is an alkyl or aryl group, such as methyl, ethyl, phenyl or naphthyl, or others as described herein), an alcohol or alkoxy group (such as alkoxy methyl, alkoxy ethyl, or groups such as phenoxy, naphthoxy etc.), an alkyl carbonyl, an aryl carbonyl, an alkoxy, an aryloxy carbonyl, a thioalkyl ether, a thioaryl ether, an amide such as —CONH₂ or —CONHR (where R is an alkyl or aryl group), a halogen (for example, F, Cl, Br or I), an alkylhalo group (such as a trifluoromethyl, a trichloromethyl, a tribromomethyl, etc.), a nitro group, a cyano group, etc.

Non-limiting examples of such structures include the following:

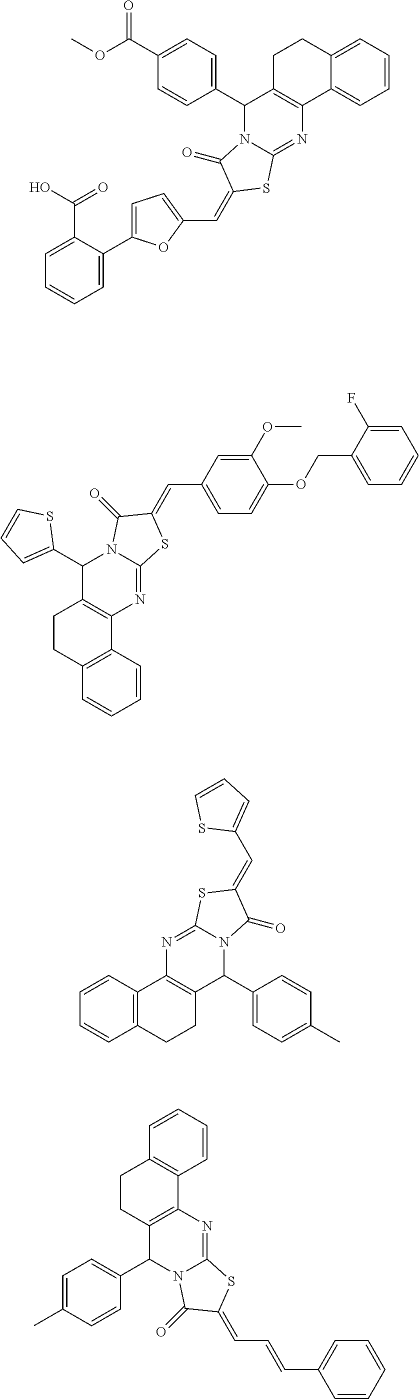

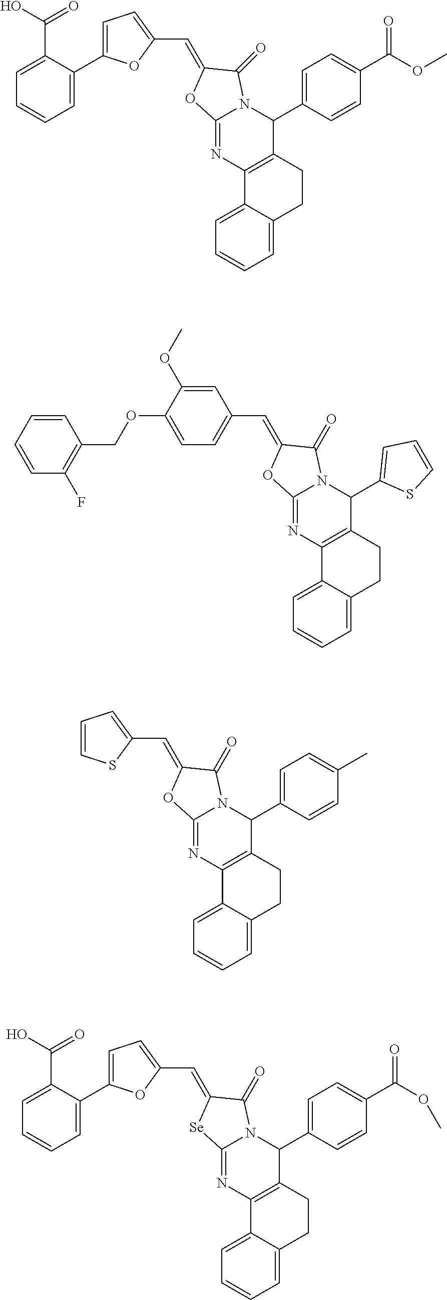 [SMILES: COC(=O)c1ccc(C2C3=C(N=c4o/c(=C\c5ccc(-c6ccccc6C(=O)O)o5)c(=O)n42)c2ccccc2CC3)cc1 ; COc1cc(/C=c2\oc3n(c2=O)C(c2cccs2)C2=C(N=3)c3ccccc3CC2)ccc1OCc1ccccc1F ; Cc1ccc(C2C3=C(N=c4o/c(=C\c5cccs5)c(=O)n42)c2ccccc2CC3)cc1 ; COC(=O)c1ccc(C2C3=C(N=c4[se]/c(=C\c5ccc(-c6ccccc6C(=O)O)o5)c(=O)n42)c2ccccc2CC3)cc1]

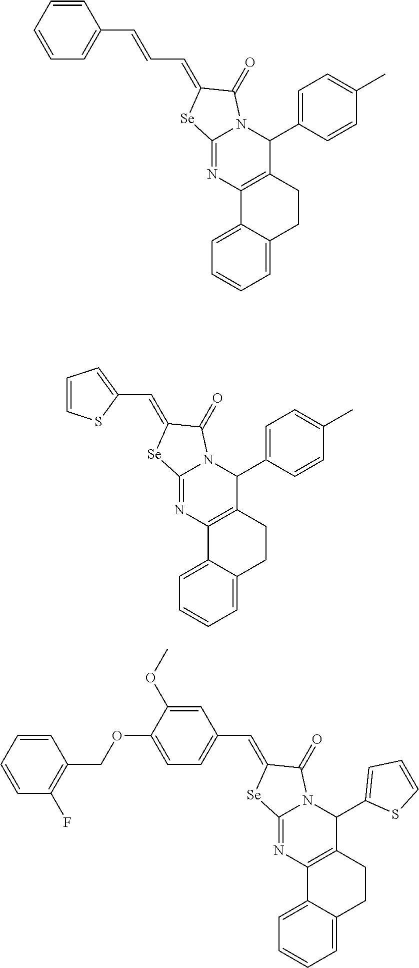

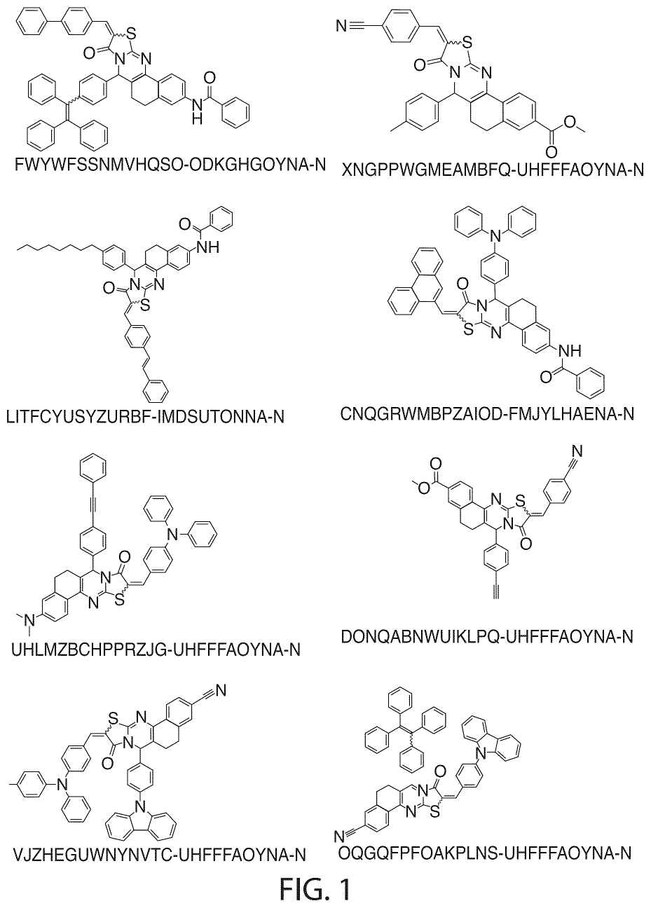

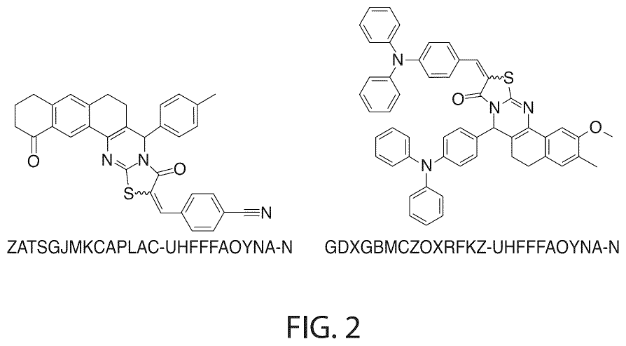

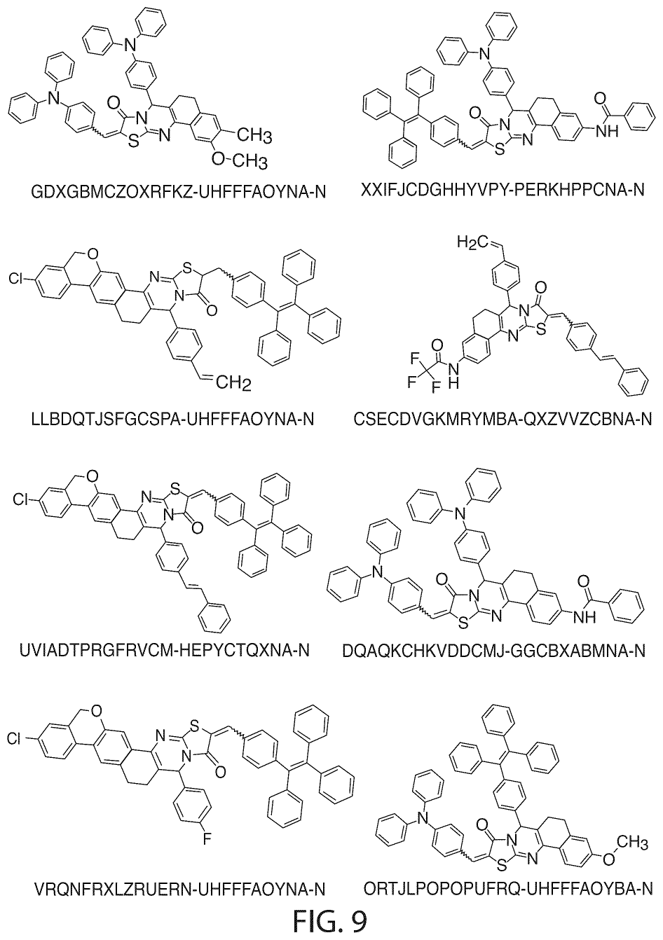

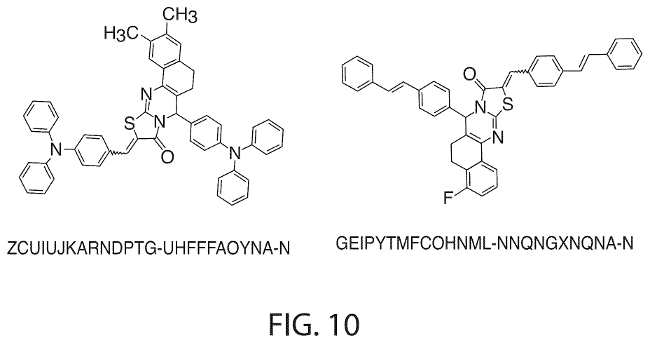

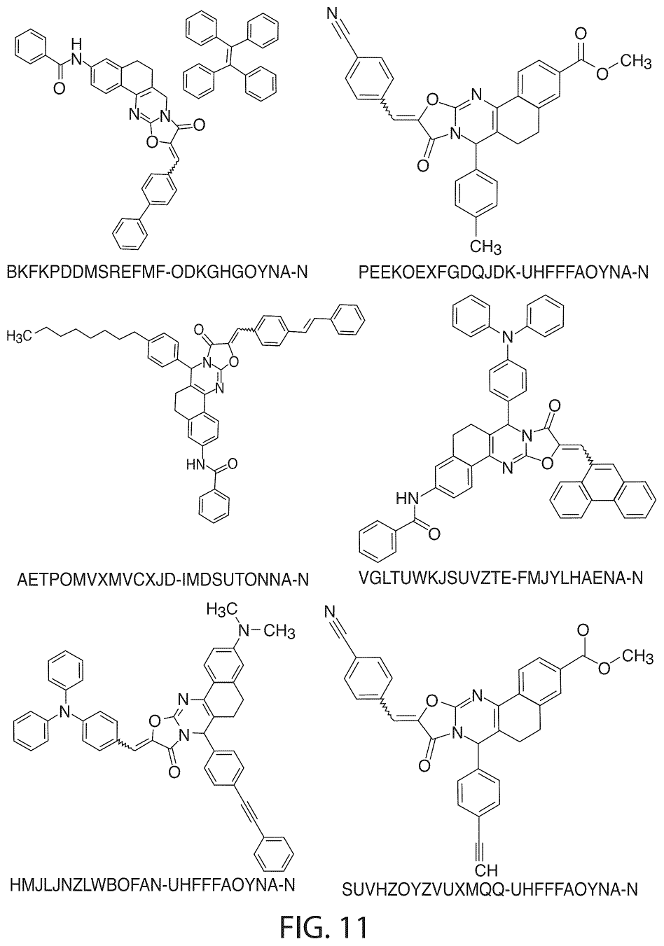

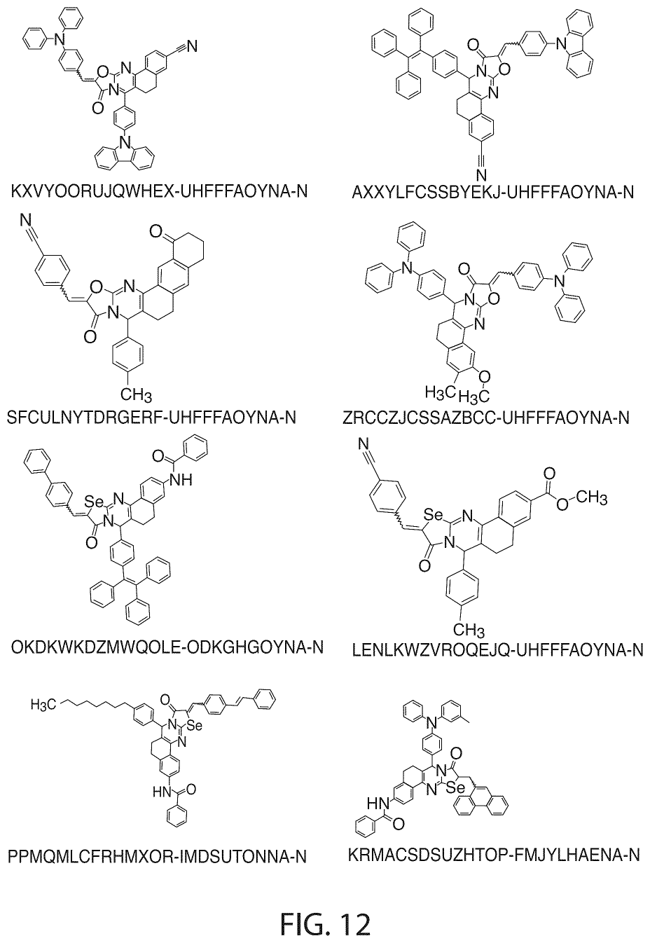

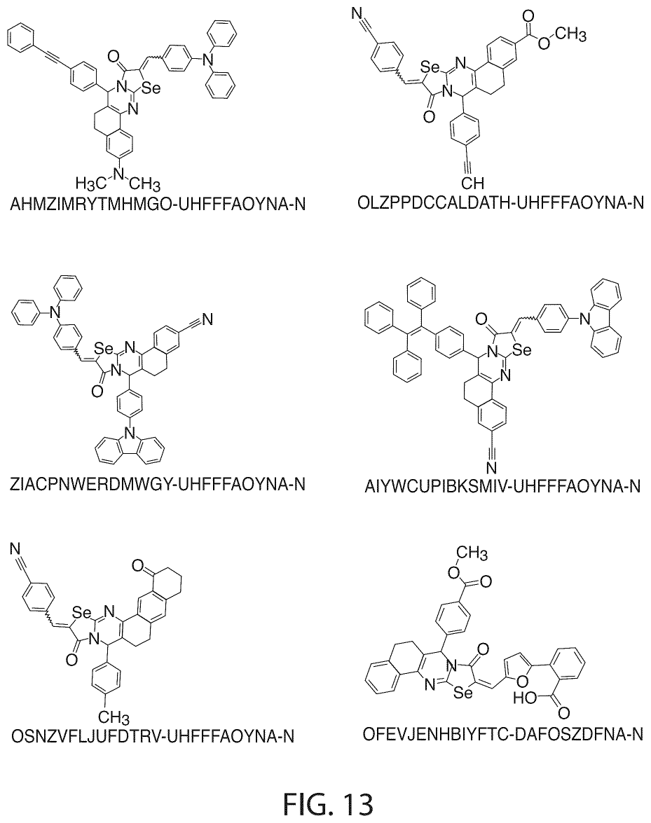

In addition, other non-limiting examples are shown in FIGS. 1, 2, and 9-13.

In another set of embodiments, the 1,3-thiazolidin-4-one may have a structure such as:

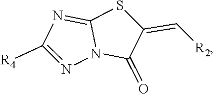

where the (forms a 5-member 1,2,4-triazole ring. In some cases, R₄ may be —H or be selected from an alkyl (such as a methyl group, an ethyl group, a propyl group, a butyl group, an isopropyl group, an isobutyl group, a tert-butyl group, or the like), a cycloalkyl (such as a cyclopropyl group, a cyclobutyl group or a cyclopentyl group, a cyclohexyl group, etc. or the like), an aromatic (such as phenyl group, a naphthyl group, an anthracene group, a fluorenyl group, or the like), a heterocyclic (such as an epoxide group, a furyl group, a pyrrolyl group, a thiazolyl group, an oxazolyl group, an imidazolyl group, a pyridyl group, a pyrazinyl group, a pyrimidinyl group, a piperidinyl group, a pyrazolyl group, etc.), a vinyl group or a propargyl group, a hydroxyl, an alkoxy (such as methoxy, ethoxy, propoxy, butoxy, phenoxy, a phenylmethoxy, a phenylethoxy, or similar), an amine such as —NH₂, an alkylamine (such as methyl amine, ethyl amine propyl amine or the like), a dialkylamine (such as dimethyl amine, diisopropyl amine, etc.) an arylamine (such as phenyl amine, naphthyl amine etc.), a diarylamine (such as diphenyl amine or the like), an amide such as —CONH₂ or —CONHR (where R is an alkyl or aryl group), an N-substituted amide (where substituent is an alkyl or an aryl group or carboxylic acid or an alkoxy carbonyl group, such as a methoxy carbonyl group, an ethoxy carbonyl group, a phenoxy carbonyl etc.), an alkyl sulfonyl (such as a methyl sulfonyl group, an ethyl sulfonyl group, a p-tolyl sulfonyl group, a cyclohexyl sulfonyl group, etc.), a ketone (such as methyl ketone, an ethyl ketone or a phenyl ketone, etc.), a sulfonamide, a nitrile, a nitro, a halogen (for example, F, Cl, Br or I), an alkylhalo group (such as a trifluoromethyl, a trichloromethyl, a tribromomethyl, etc.), an acyl, or the like.

In addition, in some cases, R₄ may be connected to the 1,3-thiazolidin-4-one via a linker. One example is shown below, where X and Y are carbon atoms, linked via a single, double, or triple bond. In some cases, the X-Y unit may repeat, e.g., 2, 3, 4, 5, 6, or more times, e.g., to form linkers of different sizes.

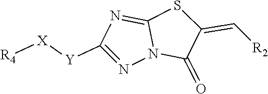

Non-limiting examples of such structures include the following:

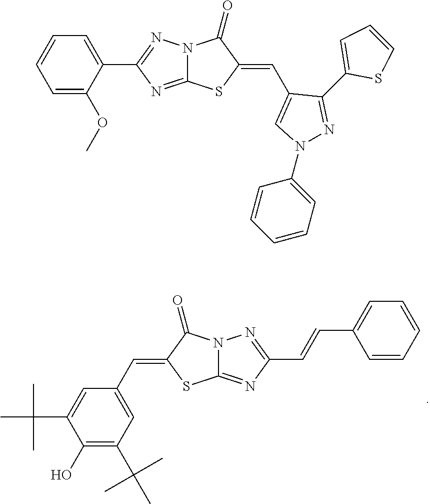 [SMILES: COc1ccccc1-c1nc2s/c(=C\c3cn(-c4ccccc4)nc3-c3cccs3)c(=O)n2n1 ; CC(C)(C)c1cc(/C=c2\sc3nc(/C=C/c4ccccc4)nn3c2=O)cc(C(C)(C)C)c1O]

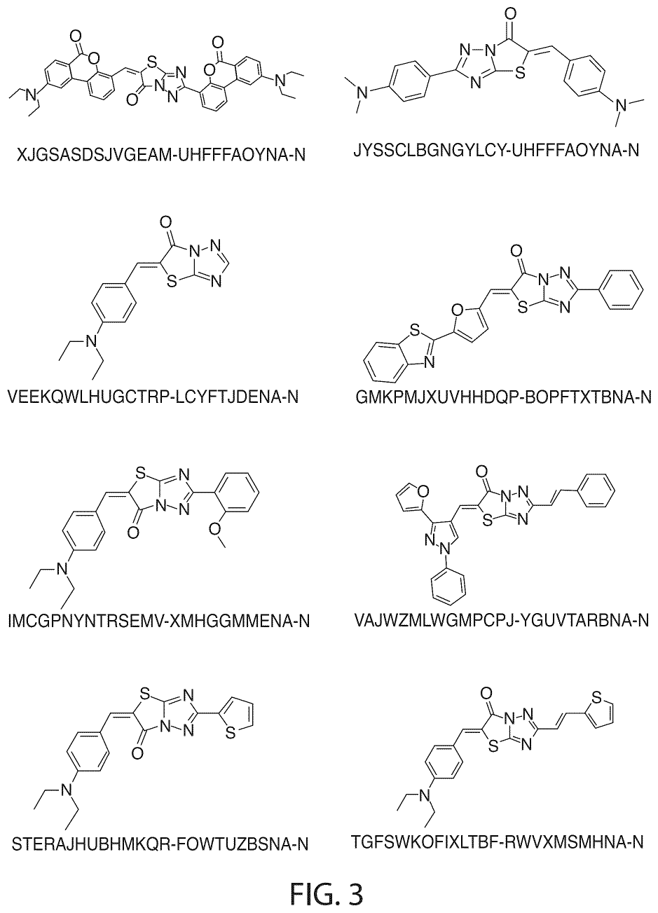

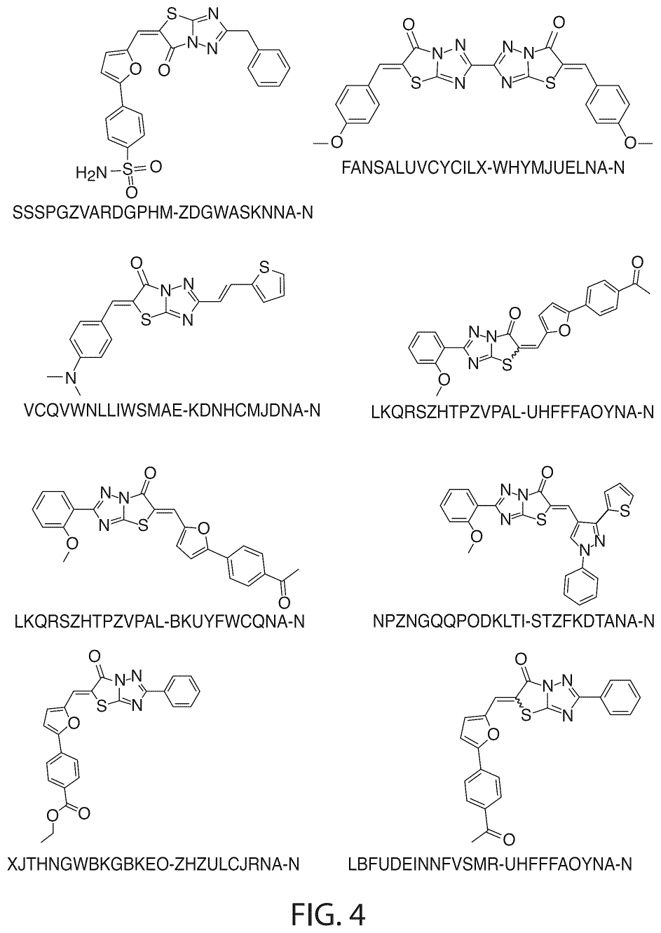

In addition, other non-limiting examples are shown in FIGS. 3-4.

In yet another set of embodiments, the 1,3-thiazolidin-4-one may have a structure such as:

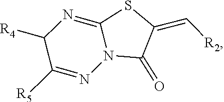

where the (forms a 6-member 1,2,4-triazine ring. In some cases, R₄ and R₅ may independently be —H or be selected from an alkyl (such as a methyl group, an ethyl group, a propyl group, a butyl group, an isopropyl group, an isobutyl group, a tert-butyl group, or the like), a cycloalkyl (such as a cyclopropyl group, a cyclobutyl group or a cyclopentyl group, a cyclohexyl group, etc. or the like), an aromatic (such as phenyl group, a naphthyl group, an anthracene group, a fluorenyl group, or the like), a heterocyclic (such as an epoxide group, a furyl group, a pyrrolyl group, a thiazolyl group, an oxazolyl group, an imidazolyl group, a pyridyl group, a pyrazinyl group, a pyrimidinyl group, a piperidinyl group, a pyrazolyl group, etc.), a vinyl group or a propargyl group, a hydroxyl, an alkoxy (such as methoxy, ethoxy, propoxy, butoxy, phenoxy, a phenylmethoxy, a phenylethoxy, or similar), an amine such as —NH₂, an alkylamine (such as methyl amine, ethyl amine propyl amine or the like), a dialkylamine (such as dimethyl amine, diisopropyl amine, etc.) an arylamine (such as phenyl amine, naphthyl amine etc.), a diarylamine (such as diphenyl amine or the like), an amide such as —CONH₂ or —CONHR (where R is an alkyl or aryl group), an N-substituted amide (where substituent is an alkyl or an aryl group or carboxylic acid or an alkoxy carbonyl group, such as a methoxy carbonyl group, an ethoxy carbonyl group, a phenoxy carbonyl etc.), an alkyl sulfonyl (such as a methyl sulfonyl group, an ethyl sulfonyl group, a p-tolyl sulfonyl group, a cyclohexyl sulfonyl group, etc.), a ketone (such as methyl ketone, an ethyl ketone or a phenyl ketone, etc.), a sulfonamide, a nitrile, a nitro, a halogen (for example, F, Cl, Br or I), an alkylhalo group (such as a trifluoromethyl, a trichloromethyl, a tribromomethyl, etc.), an acyl, or the like. In addition, in some cases, R₄ may connect with R₅ to form a ring, e.g., a 5- or 6-member ring.

Non-limiting examples of such structures include the following:

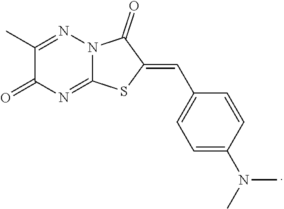

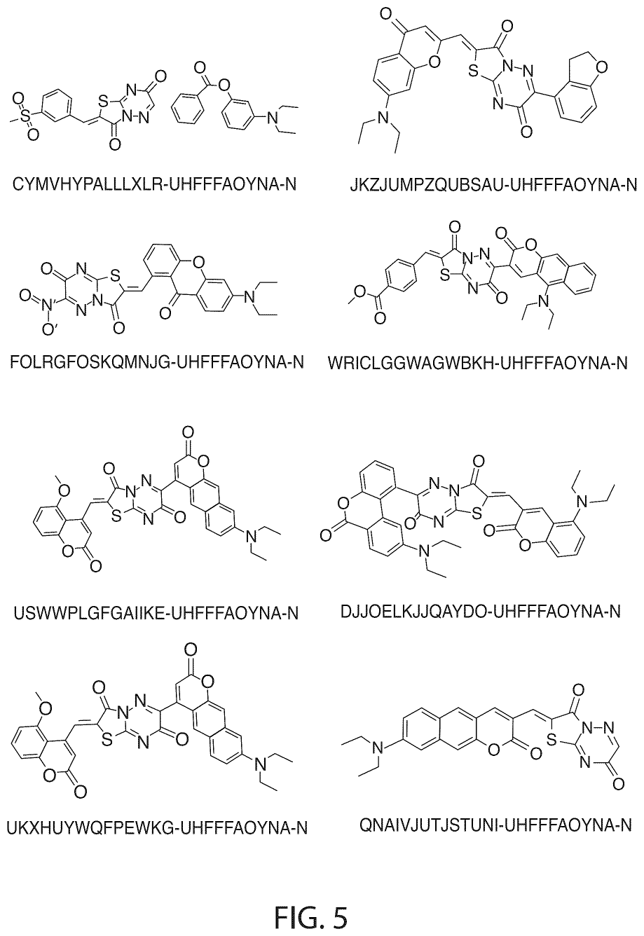

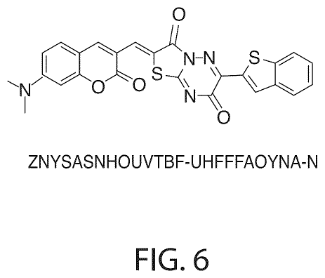

In addition, other non-limiting examples are shown in FIGS. 5-6.

In still another set of embodiments, the 1,3-thiazolidin-4-one may have a structure such as:

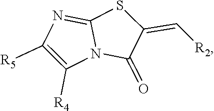

where the (forms a 5-member imidazole ring. In some cases, R₄ and R₅ may independently be —H or be selected from an alkyl (such as a methyl group, an ethyl group, a propyl group, a butyl group, an isopropyl group, an isobutyl group, a tert-butyl group, or the like), a cycloalkyl (such as a cyclopropyl group, a cyclobutyl group or a cyclopentyl group, a cyclohexyl group, etc. or the like), an aromatic (such as phenyl group, a naphthyl group, an anthracene group, a fluorenyl group, or the like), a heterocyclic (such as an epoxide group, a furyl group, a pyrrolyl group, a thiazolyl group, an oxazolyl group, an imidazolyl group, a pyridyl group, a pyrazinyl group, a pyrimidinyl group, a piperidinyl group, a pyrazolyl group, etc.), a vinyl group or a propargyl group, a hydroxyl, an alkoxy (such as methoxy, ethoxy, propoxy, butoxy, phenoxy, a phenylmethoxy, a phenylethoxy, or similar), an amine such as —NH₂, an alkylamine (such as methyl amine, ethyl amine propyl amine or the like), a dialkylamine (such as dimethyl amine, diisopropyl amine, etc.) an arylamine (such as phenyl amine, naphthyl amine etc.), a diarylamine (such as diphenyl amine or the like), an amide such as —CONH₂ or —CONHR (where R is an alkyl or aryl group), an N-substituted amide (where substituent is an alkyl or an aryl group or carboxylic acid or an alkoxy carbonyl group, such as a methoxy carbonyl group, an ethoxy carbonyl group, a phenoxy carbonyl etc.), an alkyl sulfonyl (such as a methyl sulfonyl group, an ethyl sulfonyl group, a p-tolyl sulfonyl group, a cyclohexyl sulfonyl group, etc.), a ketone (such as methyl ketone, an ethyl ketone or a phenyl ketone, etc.), a sulfonamide, a nitrile, a nitro, a halogen (for example, F, Cl, Br or I), an alkylhalo group (such as a trifluoromethyl, a trichloromethyl, a tribromomethyl, etc.), an acyl, or the like. In addition, in some cases, R₄ may connect with R₅ to form a ring, e.g., a 5- or 6-member ring.

Non-limiting examples of such structures include the following:

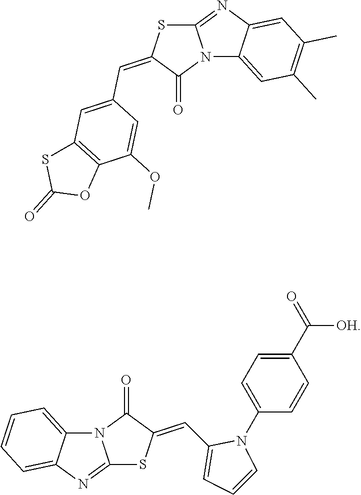 [SMILES: COc1cc(/C=c2/sc3nc4cc(C)c(C)cc4n3c2=O)cc2sc(=O)oc12 ; O=C(O)c1ccc(-n2cccc2/C=c2\sc3nc4ccccc4n3c2=O)cc1]

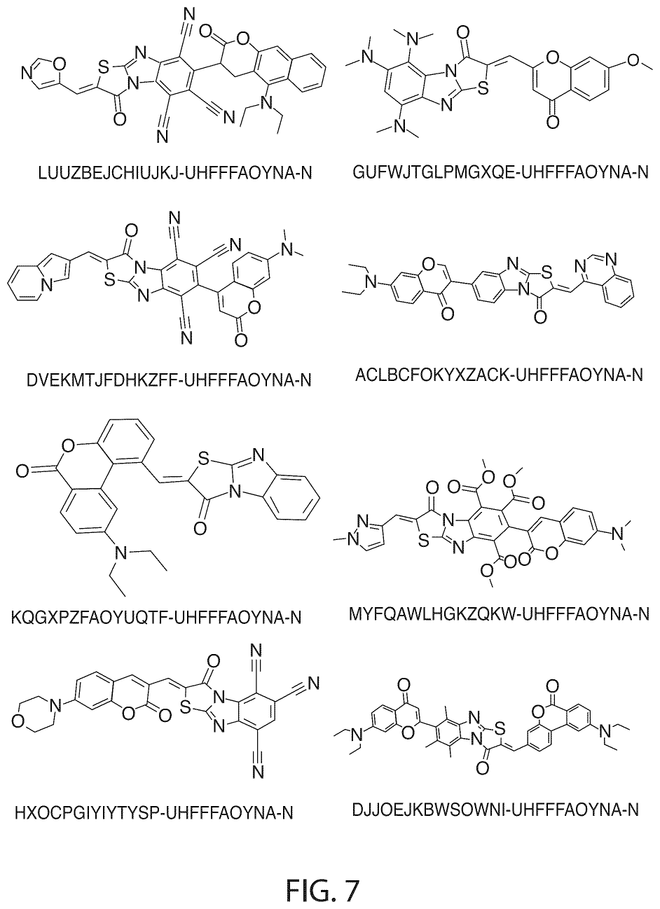

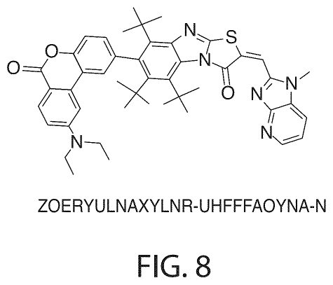

In addition, other non-limiting examples are shown in FIGS. 7-8

In some cases, the optical molecules may be relatively soluble in solvents such as water, ethanol, or toluene, e.g., at concentrations of at least 1, at least 2 mg/ml, at least 5 mg/ml, etc. In some cases, the optical molecules may be thermally stable. For example, the molecules may be relatively stable while being exposed to temperatures of at least 100° C., at least 180° C., or at least 200° C., at least 250° C., at least 290° C., etc. for at least 30 min. In some cases, the optical molecules may also exhibit resistance to leaching, e.g., while being exposed to temperatures of at least 50° C., at least 65° C., at least 100° C., at least 180° C., or at least 200° C., at least 250° C., at least 290° C., etc. for at least 72 hours. In some cases, the optical molecules may exhibit resistance to bleeding, e.g., after being submerged in either water or ethanol for at least 24 hours. In some cases, the optical molecules may exhibit resistance to ultraviolet light, e.g., after exposure for at least 24 hours, or at least 7 days.

U.S. Provisional Patent Application Ser. No. 63/296,554, filed Jan. 5, 2022, entitled “Organic Colorants, Including Pigments and Dyes, for Plastics, Inks, Paints, Coatings, And Other Applications,” is incorporated herein by reference in its entirety.

The following examples are intended to illustrate certain embodiments of the present disclosure, but do not exemplify the full scope of the disclosure.

### Example 1

In this example, a general formulation comprising colorant molecules is provided as follows.

Solubility. Solubility of candidate molecules were measured in water, ethanol, and toluene. Samples were weighed into individual vials and their masses were recorded. Upon completion, the slow addition of one solvent was added to the vials via a 1 mL syringe equipped with needle, monitoring the dissolution or dispersion of the molecules until either complete dissolution or a concentration of 2 mg/mL was achieved. If dissolution was observed prior to 2 mg/mL, the concentration was recorded. This process was repeated for all samples.

Preparation of molecules in a polypropylene matrix. The samples were weighed using a balance into individual vials and the masses were recorded. Polypropylene pellets were then added to each sample until a total desired weight percent (wt %) doping concentration was attained. The samples were then subjected to rapid mixing using an IKA Tube Mill Control 100 (22,500 RPM for three minutes) to ensure equal dispersion of the molecules in the matrix. Samples were then taken forward for the following experiments.

Thermal stability in polypropylene matrices. The thermal stability experiments used two types of measurements. First, identification of thermally promoted oxidative degradation. Approximately 250 mg of each prepared sample and polypropylene standard were placed into an aluminum pan. This process was repeated to create two nearly identical samples. The first set of samples were then placed into a vacuum oven, purged with a nitrogen atmosphere (three pump-vent cycles), and heated to 180° C. for 30 minutes. The second set of samples were placed into a vacuum oven and heated to 180° C. for 30 minutes under ambient atmosphere. Both sets of samples were evaluated for differences in color due to degradation. All samples that showed degradation were excluded for future investigation.

Second, identification of colorimetric changes under extreme temperature. For each sample, five separate samples were made into one-inch diameter discs using approximately 2.5 g of the sample in a ring mold. Using the same vacuum oven, the chamber was heated to 180° C. A single sample was then placed into the oven for five minutes of heating (under ambient atmosphere) and then removed. The oven temperature was increased by 20° C. until temperature stabilization was achieved. This process was repeated until all samples had been heated for five minutes. Upon cooling, the heated sample was then measured using a Konica Minolta CS-150 Color Meter and the tristimulus XYZ values and CIE 1931 x, y (and CIE 197 #u′, v′) values were obtained. Values were then analyzed for any color change resulting from thermally promoted degradation.

Color leaching in PP matrices. The samples that showed robust thermal stabilities were subjected to two long-term leaching experiments (from a PP matrix). First, solid-state leaching. Each sample was placed between two pieces of filter paper in a polypropylene Petri dish and placed underneath an aluminum block to ensure proper contact of the sample surface and filter paper. Samples were heated under ambient atmosphere to 65° C. for 72 hours. Upon completion, samples were removed, and the filter paper analyzed for pigment residue. All samples that underwent leaching were excluded for future investigation.

Second, solvent bleed resistance. The samples were placed into wells of appropriate size and submerged in either water or ethanol for 24 hours. Afterwards, the samples were removed to inspect solvent for the presence of color. All samples which underwent leaching were excluded for future investigation.

Color in PP matrices. This study involved all materials that showed robust thermal stability and resistance to leaching. Samples were made into 1 inch (2.54 cm) diameter discs using approximately 2.5 g of sample by melting the mixture at 180° C. for 30 minutes. Using a Konica Minolta CS-150 Color Meter, the CIE 1931 x, y (and CIE 1976 u′, v′) values were obtained. Reflectance spectra were then acquired using an Avantes spectrometer.

UV stability. For each sample, a sample was made into 1 inch (2.54 cm) diameter discs using approximately 2.5 g of pigment-polymer sample by melting the mixture at 180° C. for 30 minutes. After collecting all initial spectroscopic/colorimetric information using the methods described above, the samples were placed into a Q-Sun XE-1 chamber for accelerated weathering, including exposure to UV radiation, for a period of 24 hours. After the 24-hour exposure, the samples were removed, and spectroscopic/colorimetric data was collected. The samples were then placed back into the chamber for seven days and data was collected identically to the 24-hour period (Table 1, showing spectrophotometer outputs of pigment samples 1-3 before irradiation at 0.65 W/m² (0 hours) and after (168 hours).

TABLE 1

| | Irradiation | | | | | |
|---|---|---|---|---|---|---|
| Pigment # | (hours) | L* | a* | b* | C | H |
| 1 | 0 | 33 | 29 | 17 | 34 | 30 |
| | 168 | 40 | 37 | 20 | 42 | 29 |
| 2 | 0 | 23 | 1 | −1 | 1 | 315 |
| | 168 | 27 | 1 | −1 | 1 | 319 |
| 3 | 0 | 24 | 3 | 0 | 3 | 3 |
| | 168 | 36 | 3 | 3 | 4 | 46 |

### Example 2

This example illustrates the synthesis of a compound having a structure:

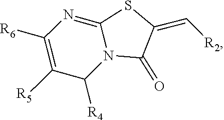

wherein R₂, R₄, R₅, and R₆ are defined as shown above.

One non-limiting synthetic scheme is as follows:

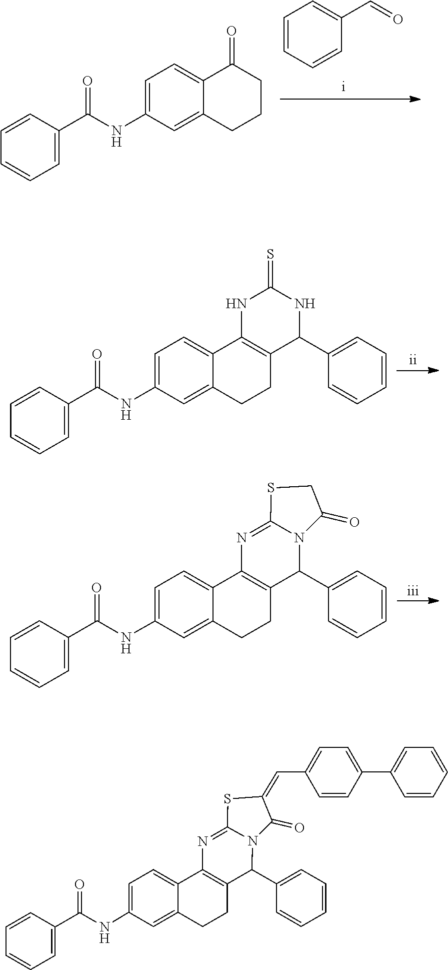

In the above reactions: i. Thiourea, KOH, ethanol, reflux; ii. Chloroacetic acid, acetic anhydride, acetic acid, reflux; iii. 4-phenylbenzaldehyde, piperidine, ethanol, reflux.

The condensation product of these tetralone derivatives with corresponding aldehyde may react with thiourea to produce a thione. This unsymmetrical thione can react with chloroacetic acid producing two isomeric cyclization products. The final thiazolidinones can be obtained by condensation of the corresponding aldehyde. In another embodiment, a single-step reaction of thione with chloroacetic acid and the corresponding aldehyde may be used. A similar synthetic route is applicable to other derivatives where S is replaced with other atoms such as O and Se.

Another non-limiting synthetic scheme is as follows:

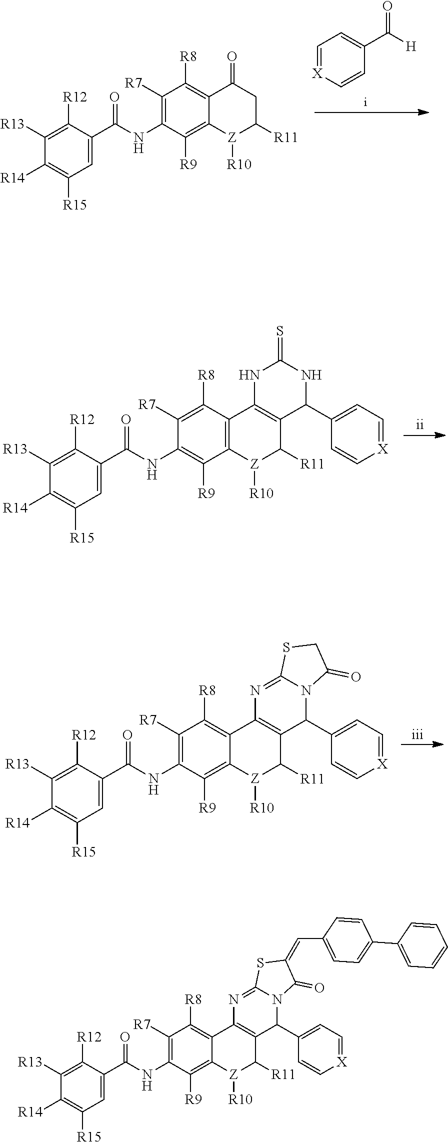

In the above reactions: i. Thiourea, KOH, ethanol, reflux; ii. Chloroacetic acid, acetic anhydride, acetic acid, reflux; iii. 4-phenylbenzaldehyde, piperidine, ethanol, reflux.

X is N or CR₁₇. Z is N or CR₁₆. R₆, R₇, R₉, R₁₀, R₁₁, R₁₂, R₁₃, R₁₄, R₁₅, R₁₆, and R₁₇ each independently is —H, or in some embodiments, an alkyl (such as methyl, ethyl, propyl, butyl, isopropyl, isobutyl, tertbutyl, or the like), a cycloalkyl (e.g., cyclopropyl, cyclobutyl, cyclopentyl, cyclohexyl, etc.), an aromatic (such as phenyl, naphthyl, anthracene, fluorenyl, or the like), a heterocyclic (such as an epoxide, furyl, pyrrolyl, thiazolyl, oxazolyl, an imidazolyl, pyridyl, pyrazinyl, pyrimidinyl, piperidinyl, pyrazolyl, etc.), a vinyl group or a propargyl group, a hydroxyl, an alkoxy (such as methoxy, ethoxy, propoxy, butoxy, phenoxy, a phenylmethoxy, a phenylethoxy, etc.), an amine (e.g., —NH₂, an alkylamine (such as methyl amine, ethyl amine propyl amine, or the like), a dialkylamine (such as dimethyl amine, diisopropyl amine, etc.), an arylamine (such as phenyl amine, naphthyl amine etc.), a diarylamine (such as diphenyl amine or the like), an amide such as —CONH₂ or —CONHR (where R is an alkyl or aryl group), an N-substituted amide (e.g., where the substituent is an alkyl, an aryl, a carboxylic acid, an alkoxy carbonyl such as methoxy carbonyl, ethoxy carbonyl, phenoxy carbonyl, etc.), an alkyl sulfonyl (such as methyl sulfonyl, ethyl sulfonyl, p-tolyl sulfonyl, cyclohexyl sulfonyl, etc.), a ketone (such as methyl ketone, ethyl ketone, phenyl ketone, etc.), sulfonamide, nitrile, nitro, or the like.

Yet another non limiting scheme is shown below:

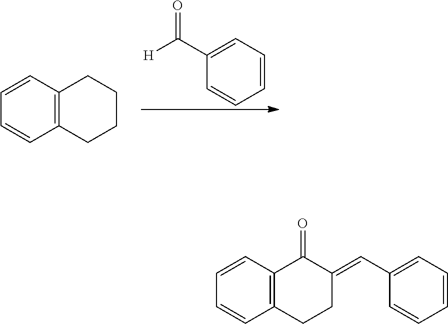 [SMILES: c1ccc2c(c1)CCCC2 ; O=Cc1ccccc1 ; O=C1/C(=C/c2ccccc2)CCc2ccccc21]

where:

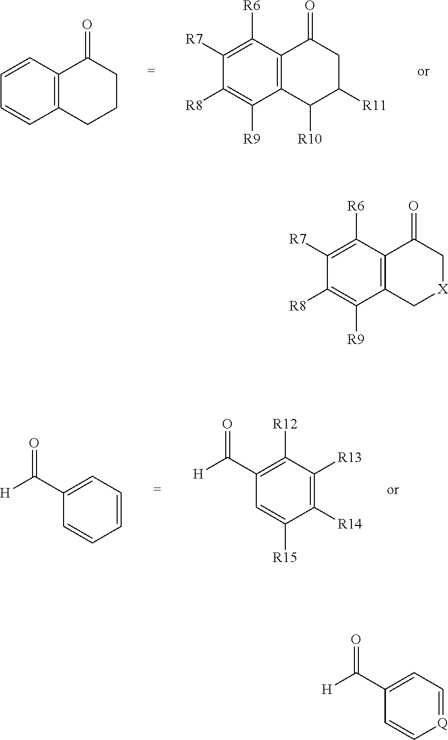

In this example, Q is N or CR₁₆. X is NR₁₇ or CR₁₈R₁₉. R₆, R₇, R₈, R₉, R₁₀, R₁₁, R₁₂, R₁₃, R₁₄, R₁₅, R₁₆, R₁₇, R₁₈, and R₁₉ each independently is —H, or in some embodiments, an alkyl (such as methyl, ethyl, propyl, butyl, isopropyl, isobutyl, tert-butyl, or the like), a cycloalkyl (e.g., cyclopropyl, cyclobutyl, cyclopentyl, cyclohexyl, etc.), an aromatic (such as phenyl, naphthyl, anthracene, fluorenyl, or the like), a heterocyclic (such as an epoxide, furyl, pyrrolyl, thiazolyl, oxazolyl, an imidazolyl, pyridyl, pyrazinyl, pyrimidinyl, piperidinyl, pyrazolyl, etc.), a vinyl group or a propargyl group, a hydroxyl, an alkoxy (such as methoxy, ethoxy, propoxy, butoxy, phenoxy, a phenylmethoxy, a phenylethoxy, etc.), an amine (e.g., —NH₂, an alkylamine (such as methyl amine, ethyl amine propyl amine, or the like), a dialkylamine (such as dimethyl amine, diisopropyl amine, etc.), an arylamine (such as phenyl amine, naphthyl amine etc.), a diarylamine (such as diphenyl amine or the like), an amide such as —CONH₂ or —CONHR (where R is an alkyl or aryl group), an N-substituted amide (e.g., where the substituent is an alkyl, an aryl, a carboxylic acid, an alkoxy carbonyl such as methoxy carbonyl, ethoxy carbonyl, phenoxy carbonyl, etc.), an alkyl sulfonyl (such as methyl sulfonyl, ethyl sulfonyl, p-tolyl sulfonyl, cyclohexyl sulfonyl, etc.), a ketone (such as methyl ketone, ethyl ketone, phenyl ketone, etc.), sulfonamide, nitrile, nitro, or the like.

### Example 3

This example illustrates the synthesis of a compound having a structure:

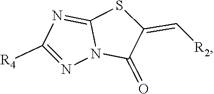

where R₂ and R₄ are defined as shown above.

One non-limiting synthetic scheme is as follows:

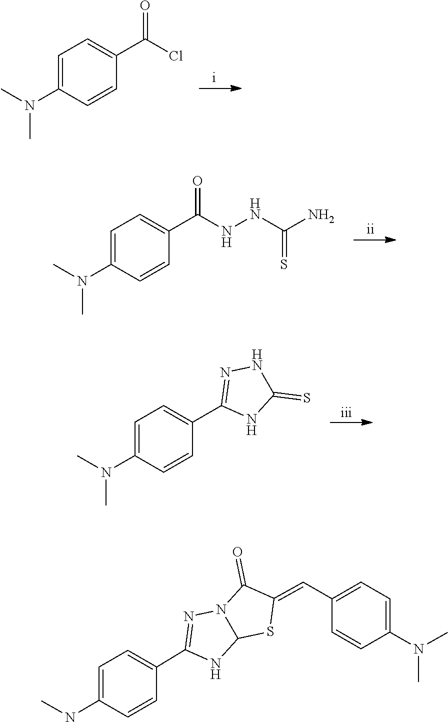

In the above reactions: i. Thiosemicarbazide, THF, 0° C.; ii. NaOH, 150° C., MW; iii. Chloroacetic acid, 4-dimethylaminobenzaldehyde, sodium acetate, acetic anhydride, acetic acid, reflux.

Refluxing the acid chloride with thiosemicarbazide may be used to produce acyl thiosemicarbazides, which cyclizes upon treating with base produces the corresponding 3-substituted-5-mercapto-1,2,4-triazoles. These, when treated with chloroacetic acid and aldehyde in presence of acetic anhydride and sodium acetate, may produce thiazolo[3,2-b]-1,2,4-triazoles.

### Example 4

This example illustrates the synthesis of a compound having a structure:

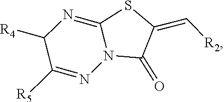

where R₂, R₄, and R₅ are defined as shown above.

One non-limiting synthetic scheme is as follows:

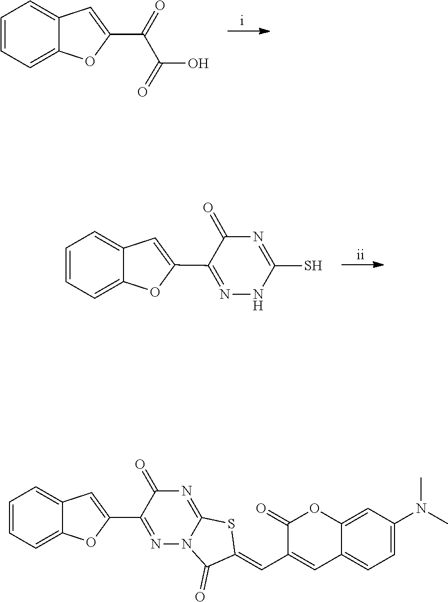 [SMILES: O=C(O)C(=O)c1cc2ccccc2o1 ; O=c1nc(S)[nH]nc1-c1cc2ccccc2o1 ; CN(C)c1ccc2cc(/C=c3\sc4nc(=O)c(-c5cc6ccccc6o5)nn4c3=O)c(=O)oc2c1]

In the above reactions: i. Thiosemicarbazide, THF, reflux, NaOH, reflux. ii. Chloroacetic acid, 7-dimethylaminocoumarine-3-aldehyde, sodium acetate, acetic anhydride, acetic acid, reflux.

In these reactions, the glyoxalic acid derivative may react with thiosemicarbazide and cyclizes in presence of a base to produce a 3-thio-1,2,4-triazin-5-one, which upon condensation in presence of chloroacetic acid and the corresponding aldehyde may produce a desired product.

### Example 5

This example illustrates the synthesis of a compound having a structure:

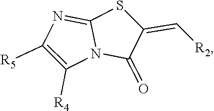

where R₂, R₄, and R₅ are defined as shown above.

One non-limiting synthetic scheme is as follows:

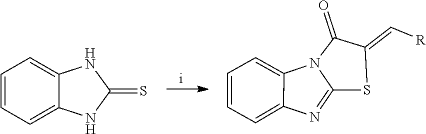

In the above reactions: i. Chloroacetic acid, RCHO, solvent free, 110° C., MW.

In this example, the thiourea derivative reacts with chloroacetic acid and the corresponding aldehyde, producing the condensation product. Depending on the thiourea substitution and the aldehyde, structures such as those shown here may be generated.

### Example 6

One non-limiting synthetic scheme is as follows:

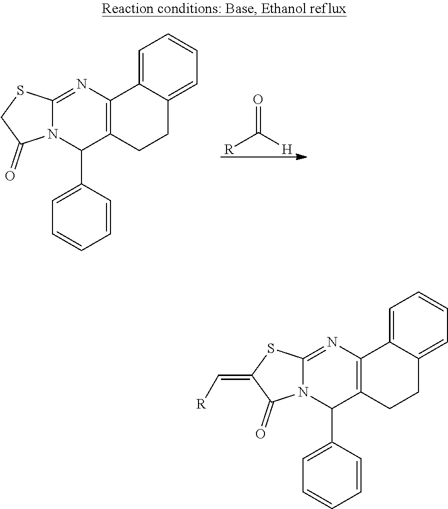

In this example, the exocyclic double bond may be introduced via condensation reaction of a core structure with aldehyde under mild basic conditions in a solvent such as ethanol at a higher temperature.

The core structure in this example can be synthesized in three steps from tetralone, aldehyde and thiourea, followed by reacting with the acid chloride:

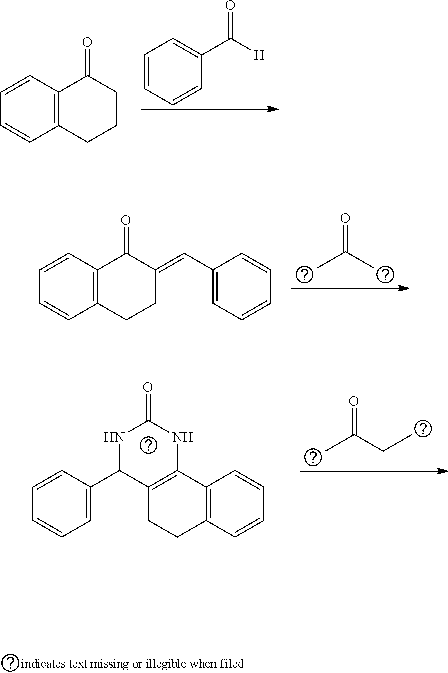

Various core molecules can also be synthesized in this fashion using substituted tetralones and aldehydes.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
coating the surface of an article with a colorant comprising an aza-heterocyclic ring system containing a chalcogen.

2. The method of claim 1, wherein the colorant is a pigment.

3. The method of claim 1, wherein the colorant is a dye.

4. The method of claim 1, wherein the colorant is contained within a paint.

5. The method of claim 1, wherein the colorant is contained within an ink.

6. The method of claim 1, wherein the colorant is contained within a paste.

7. The method of claim 1, wherein the colorant is contained within a lacquer.

8. The method of claim 1, wherein the colorant is contained within a polymer resin.

9. The method of claim 1, wherein the colorant is contained within a plastic.

10. The method of claim 1, wherein the colorant is contained within a melt.

11. The method of claim 1, wherein the chalcogen is O.

12. The method of claim 1, wherein the chalcogen is S.

13. The method of claim 1, wherein the chalcogen is Se.

14. The method of claim 1, wherein the colorant has a structure: 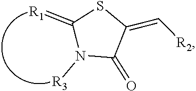
wherein X is a chalcogen, R₂ is a moiety conjugated to the 1,3-thiazolidin-4-one, and R₁ and R₃ are connected via (to form a 5- or 6-member ring.

15. The method of claim 14, wherein the (forms a 6-member pyrimidine ring.

16. The method of any one of claims 1-15, wherein the aza-heterocyclic ring system is an oxazolidinone or a selenazolidinone.

17. The method of any one of claims 1-16, wherein the aza-heterocyclic ring system has a structure:

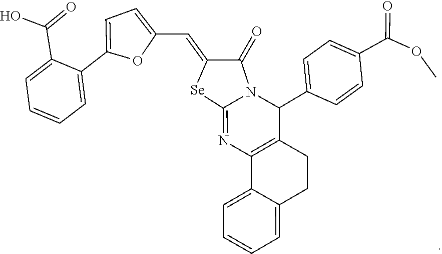 [SMILES: COC(=O)c1ccc(C2C3=C(N=c4[se]/c(=C\c5ccc(-c6ccccc6C(=O)O)o5)c(=O)n42)c2ccccc2CC3)cc1]

18. The method of any one of claims 1-16, wherein the aza-heterocyclic ring system has a structure:

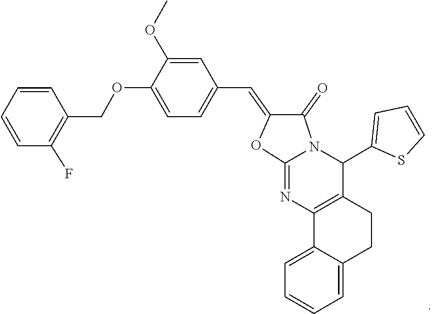 [SMILES: COc1cc(/C=c2\oc3n(c2=O)C(c2cccs2)C2=C(N=3)c3ccccc3CC2)ccc1OCc1ccccc1F]

19. The method of any one of claims 1-16, wherein the aza-heterocyclic ring system has a structure:

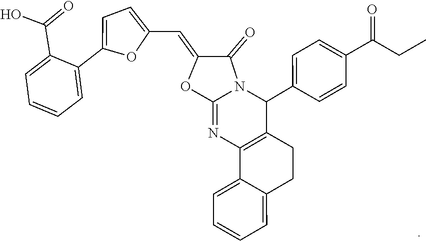 [SMILES: CCC(=O)c1ccc(C2C3=C(N=c4o/c(=C\c5ccc(-c6ccccc6C(=O)O)o5)c(=O)n42)c2ccccc2CC3)cc1]

20. The method of any one of claims 1-16, wherein the aza-heterocyclic ring system has a structure:

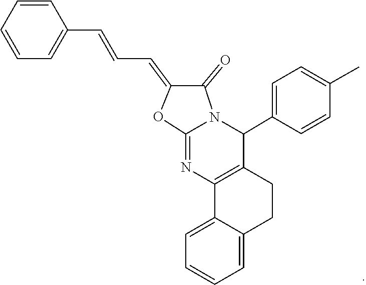 [SMILES: Cc1ccc(C2C3=C(N=c4o/c(=C\C=C\c5ccccc5)c(=O)n42)c2ccccc2CC3)cc1]

21. The method of any one of claims 1-16, wherein the aza-heterocyclic ring system has a structure:

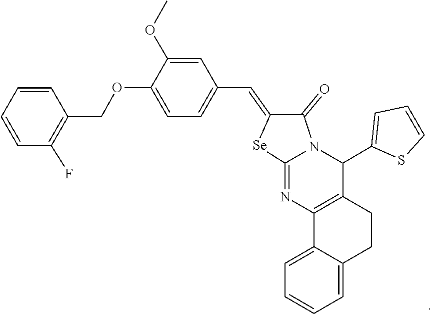 [SMILES: COc1cc(/C=c2\[se]c3n(c2=O)C(c2cccs2)C2=C(N=3)c3ccccc3CC2)ccc1OCc1ccccc1F]

22. The method of any one of claims 1-16, wherein the aza-heterocyclic ring system has a structure:

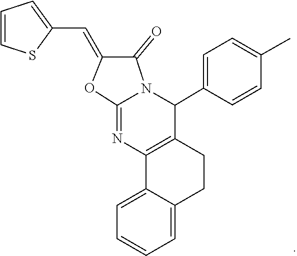 [SMILES: Cc1ccc(C2C3=C(N=c4o/c(=C\c5cccs5)c(=O)n42)c2ccccc2CC3)cc1]

23. The method of any one of claims 1-16, wherein the aza-heterocyclic ring system has a structure:

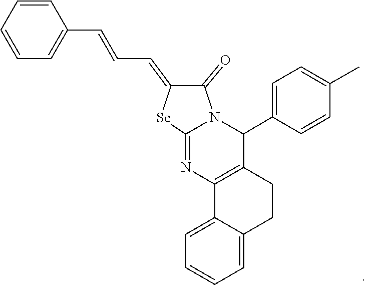 [SMILES: Cc1ccc(C2C3=C(N=c4[se]/c(=C\C=C\c5ccccc5)c(=O)n42)c2ccccc2CC3)cc1]

24. The method of any one of claims 1-16, wherein the aza-heterocyclic ring system has a structure:

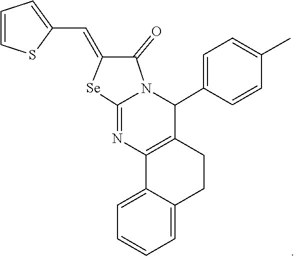 [SMILES: Cc1ccc(C2C3=C(N=c4[se]/c(=C\c5cccs5)c(=O)n42)c2ccccc2CC3)cc1]

25. The method of any one of claims 1-16, wherein the aza-heterocyclic ring system is selected from the group consisting of the following compounds, each identified by a first hash block of an InChIKey representation of the compound:
BKFKPDDMSREFMF,
PEEKOEXFGDQJDK,
AETPOMVXMVCXJD,
VGLTUWKJSUVZTE,
HMJLJNZLWBOFAN,
SUVHZOYZVUXMQQ,
KXVYOORUJQWHEX,
AXXYLFCSSBYEKJ,
SFCULNYTDRGERF,
ZRCCZJCSSAZBCC,
OKDKWKDZMWQOLE,
LENLKWZVROQEJQ,
PPMQMLCFRHMXOR,
KRMACSDSUZHTOP,
AHMZIMRYTMHMGO,
OLZPPDCCALDATH,
ZIACPNWERDMWGY,
AIYWCUPIBKSMIV,
OSNZVFLJUFDTRV,
and
OFEVJENHBIYFTC.

26. A colorant for use in coloring a material, comprising an aza-hetreocyclic ring system containing a chalcogen.

27. The colorant of claim 26, wherein the colorant is a pigment.

28. The colorant of claim 26, wherein the colorant is a dye.

29. The colorant of claim 26, wherein the colorant is contained within a paint.

30. The colorant of claim 26, wherein the colorant is contained within an ink.

31. The colorant of claim 26, wherein the colorant is contained within a paste.

32. The colorant of claim 26, wherein the colorant is contained within a lacquer.

33. The colorant of claim 26, wherein the colorant is contained within a polymer resin.

34. The colorant of claim 26, wherein the colorant is contained within a plastic.

35. The colorant of claim 26, wherein the colorant is contained within a melt.

36. The colorant of claim 26, wherein the chalcogen is O.

37. The colorant of claim 26, wherein the chalcogen is S.

38. The colorant of claim 26, wherein the chalcogen is Se.

39. The colorant of claim 26, wherein the colorant has a structure: 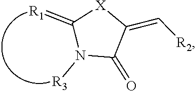
wherein X is a chalcogen, R₂ is a moiety conjugated to the 1,3-thiazolidin-4-one, and R₁ and R₃ are connected via (to form a 5- or 6-member ring.

40. The colorant of claim 39, wherein the (forms a 6-member pyrimidine ring.

41. The colorant of any one of claims 26-40, wherein the aza-heterocyclic ring system is an oxazolidinone or a selenazolidinone.

42. The colorant of any one of claims 26-41, wherein the aza-heterocyclic ring system has a structure:

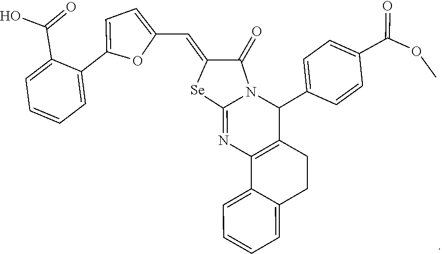 [SMILES: COC(=O)c1ccc(C2C3=C(N=c4[se]/c(=C\c5ccc(-c6ccccc6C(=O)O)o5)c(=O)n42)c2ccccc2CC3)cc1]

43. The colorant of any one of claims 26-41, wherein the aza-heterocyclic ring system has a structure:

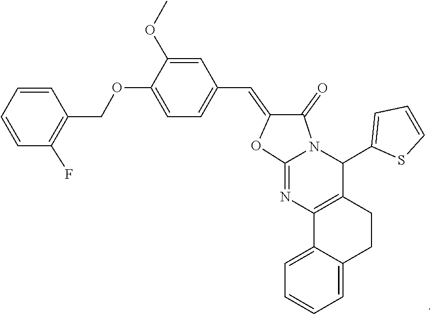 [SMILES: COc1cc(/C=c2\oc3n(c2=O)C(c2cccs2)C2=C(N=3)c3ccccc3CC2)ccc1OCc1ccccc1F]

44. The colorant of any one of claims 26-41, wherein the aza-heterocyclic ring system has a structure:

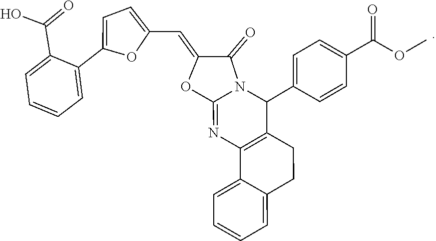 [SMILES: COC(=O)c1ccc(C2C3=C(N=c4o/c(=C\c5ccc(-c6ccccc6C(=O)O)o5)c(=O)n42)c2ccccc2CC3)cc1]

45. The colorant of any one of claims 26-41, wherein the aza-heterocyclic ring system has a structure:

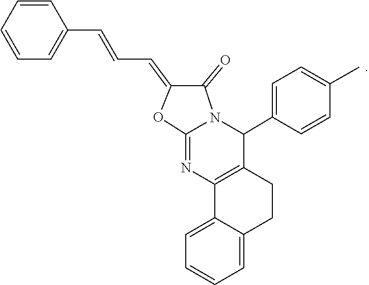 [SMILES: Cc1ccc(C2C3=C(N=c4o/c(=C\C=C\c5ccccc5)c(=O)n42)c2ccccc2CC3)cc1]

46. The colorant of any one of claims 26-41, wherein the aza-heterocyclic ring system has a structure:

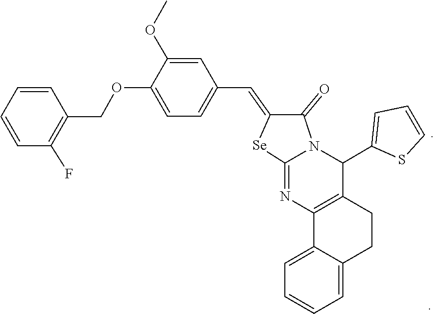 [SMILES: COc1cc(/C=c2\[se]c3n(c2=O)C(c2cccs2)C2=C(N=3)c3ccccc3CC2)ccc1OCc1ccccc1F]

47. The colorant of any one of claims 26-41, wherein the aza-heterocyclic ring system has a structure:

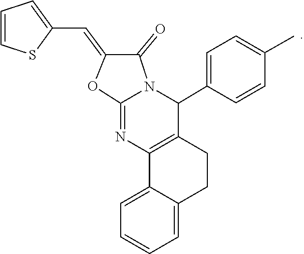 [SMILES: Cc1ccc(C2C3=C(N=c4o/c(=C\c5cccs5)c(=O)n42)c2ccccc2CC3)cc1]

48. The colorant of any one of claims 26-41, wherein the aza-heterocyclic ring system has a structure:

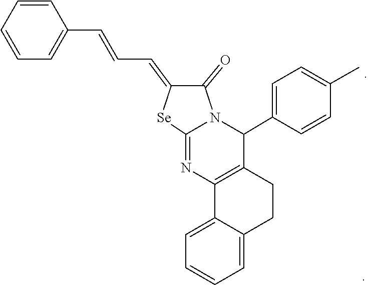 [SMILES: Cc1ccc(C2C3=C(N=c4[se]/c(=C\C=C\c5ccccc5)c(=O)n42)c2ccccc2CC3)cc1]

49. The colorant of any one of claims 26-41, wherein the aza-heterocyclic ring system has a structure:

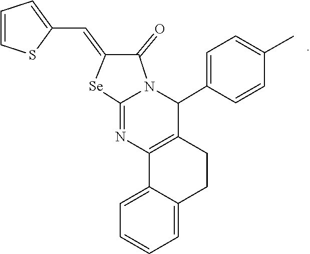 [SMILES: Cc1ccc(C2C3=C(N=c4[se]/c(=C\c5cccs5)c(=O)n42)c2ccccc2CC3)cc1]

50. The colorant of any one of claims 26-41, wherein the aza-heterocyclic ring system is selected from the group consisting of the following compounds, each identified by a first hash block of an InChIKey representation of the compound:
BKFKPDDMSREFMF,
PEEKOEXFGDQJDK,
AETPOMVXMVCXJD,
VGLTUWKJSUVZTE,
HMJLJNZLWBOFAN,
SUVHZOYZVUXMQQ,
KXVYOORUJQWHEX,
AXXYLFCSSBYEKJ,
SFCULNYTDRGERF,
ZRCCZJCSSAZBCC,
OKDKWKDZMWQOLE,
LENLKWZVROQEJQ,
PPMQMLCFRHMXOR,
KRMACSDSUZHTOP,
AHMZIMRYTMHMGO,
OLZPPDCCALDATH,
ZIACPNWERDMWGY,
AIYWCUPIBKSMIV,
OSNZVFLJUFDTRV,
and
OFEVJENHBIYFTC.

51. A method, comprising:
embedding a colorant comprising aza-hetreocyclic ring system containing a chalcogen in an article.

52. The method of claim 51, wherein the colorant is a pigment.

53. The method of claim 51, wherein the colorant is a dye.

54. The method of claim 51, wherein the colorant is contained within a paint.

55. The method of claim 51, wherein the colorant is contained within an ink.

56. The method of claim 51, wherein the colorant is contained within a paste.

57. The method of claim 51, wherein the colorant is contained within a lacquer.

58. The method of claim 51, wherein the colorant is contained within a polymer resin.

59. The method of claim 51, wherein the colorant is contained within a plastic.

60. The method of claim 51, wherein the colorant is contained within a melt.

61. The method of claim 51, wherein the chalcogen is O.

62. The method of claim 51, wherein the chalcogen is S.

63. The method of claim 51, wherein the chalcogen is Se.

64. The method of claim 51, wherein the 1,3-thiazolidin-4-one has a structure: 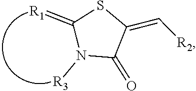
wherein X is a chalcogen, R₂ is a moiety conjugated to the 1,3-thiazolidin-4-one, and R₁ and R₃ are connected via (to form a 5- or 6-member ring.

65. The method of claim 64, wherein the (forms a 6-member pyrimidine ring.

66. The method of any one of claims 51-65, wherein the aza-heterocyclic ring system is an oxazolidinone or a selenazolidinone.

67. The method of any one of claims 51-66, wherein the aza-heterocyclic ring system has a structure:

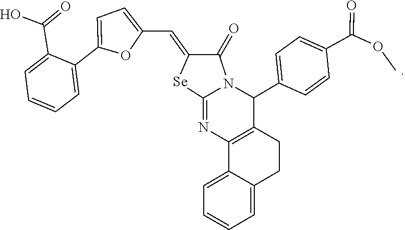 [SMILES: COC(=O)c1ccc(C2C3=C(N=c4[se]/c(=C\c5ccc(-c6ccccc6C(=O)O)o5)c(=O)n42)c2ccccc2CC3)cc1]

68. The method of any one of claims 51-66, wherein the aza-heterocyclic ring system has a structure:

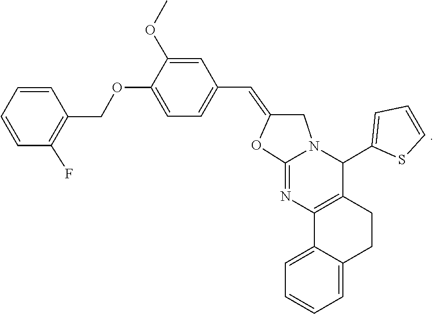 [SMILES: COc1cc(/C=C2/CN3C(=NC4=C(CCc5ccccc54)C3c3cccs3)O2)ccc1OCc1ccccc1F]

69. The method of any one of claims 51-66, wherein the aza-heterocyclic ring system has a structure:

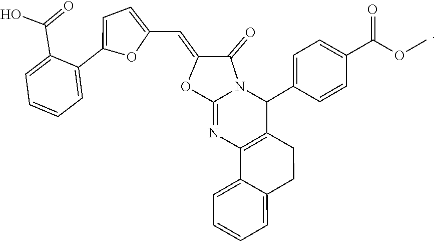 [SMILES: COC(=O)c1ccc(C2C3=C(N=c4o/c(=C\c5ccc(-c6ccccc6C(=O)O)o5)c(=O)n42)c2ccccc2CC3)cc1]

70. The method of any one of claims 51-66, wherein the aza-heterocyclic ring system has a structure:

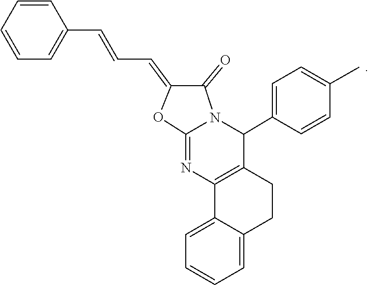 [SMILES: Cc1ccc(C2C3=C(N=c4o/c(=C\C=C\c5ccccc5)c(=O)n42)c2ccccc2CC3)cc1]

71. The method of any one of claims 51-66, wherein the aza-heterocyclic ring system has a structure:

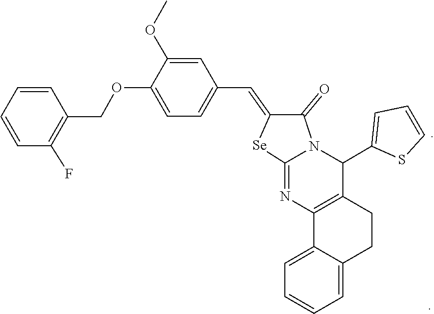 [SMILES: COc1cc(/C=c2\[se]c3n(c2=O)C(c2cccs2)C2=C(N=3)c3ccccc3CC2)ccc1OCc1ccccc1F]

72. The method of any one of claims 51-66, wherein the aza-heterocyclic ring system has a structure:

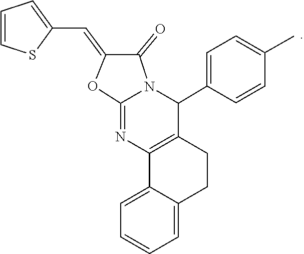 [SMILES: Cc1ccc(C2C3=C(N=c4o/c(=C\c5cccs5)c(=O)n42)c2ccccc2CC3)cc1]

73. The method of any one of claims 51-66, wherein the aza-heterocyclic ring system has a structure:

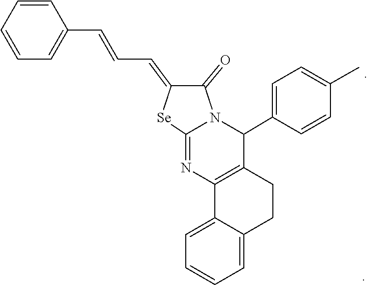 [SMILES: Cc1ccc(C2C3=C(N=c4[se]/c(=C\C=C\c5ccccc5)c(=O)n42)c2ccccc2CC3)cc1]

74. The method of any one of claims 51-66, wherein the aza-heterocyclic ring system has a structure:

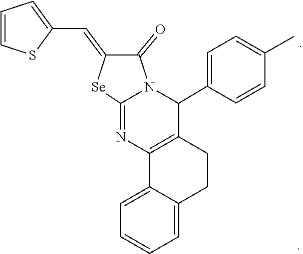 [SMILES: Cc1ccc(C2C3=C(N=c4[se]/c(=C\c5cccs5)c(=O)n42)c2ccccc2CC3)cc1]

75. The method of any one of claims 51-66, wherein the aza-heterocyclic ring system is selected from the group consisting of the following compounds, each identified by a first hash block of an InChIKey representation of the compound:
BKFKPDDMSREFMF,
PEEKOEXFGDQJDK,
AETPOMVXMVCXJD,
VGLTUWKJSUVZTE,
HMJLJNZLWBOFAN,
SUVHZOYZVUXMQQ,
KXVYOORUJQWHEX,
AXXYLFCSSBYEKJ,
SFCULNYTDRGERF,
ZRCCZJCSSAZBCC,
OKDKWKDZMWQOLE,
LENLKWZVROQEJQ,
PPMQMLCFRHMXOR,
KRMACSDSUZHTOP,
AHMZIMRYTMHMGO,
OLZPPDCCALDATH,
ZIACPNWERDMWGY,
AIYWCUPIBKSMIV,
OSNZVFLJUFDTRV,
and
OFEVJENHBIYFTC.

76. A method, comprising:
coating the surface of an article with a colorant comprising a 1,3-thiazolidin-4-one.

77. The method of claim 76, wherein the colorant is a pigment.

78. The method of claim 76, wherein the colorant is a dye.

79. The method of any one of claims 76-78, wherein the colorant is contained within a paint.

80. The method of any one of claims 76-78, wherein the colorant is contained within an ink.

81. The method of any one of claims 76-78, wherein the colorant is contained within a paste.

82. The method of any one of claims 76-78, wherein the colorant is contained within a lacquer.

83. The method of any one of claims 76-78, wherein the colorant is contained within a polymer resin.

84. The method of any one of claims 76-78, wherein the colorant is contained within a plastic.

85. The method of any one of claims 76-78, wherein the colorant is contained within a melt.

86. The method of any one of claims 76-85, wherein the 1,3-thiazolidin-4-one has a structure: 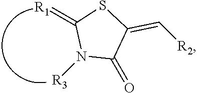
wherein R₂ is a moiety conjugated to the 1,3-thiazolidin-4-one, and R₁ and R₃ are connected via (to form a 5- or 6-member ring.

87. The method of claim 86, wherein the (forms a 6-member pyrimidine ring.

88. The method of any one of claims 86 or 87, wherein the 1,3-thiazolidin-4-one has a structure: 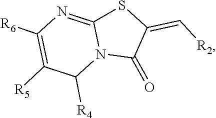
wherein R₅ is connected to one of R₄ or R₆ to form a 5- or 6-member ring, and the other of R₄ or R₆ is selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

89. The method of any one of claims 86-88, wherein the 1,3-thiazolidin-4-one has a structure:

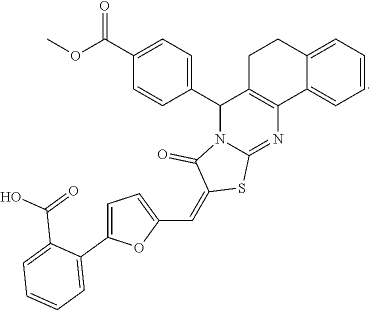 [SMILES: COC(=O)c1ccc(C2C3=C(N=c4s/c(=C/c5ccc(-c6ccccc6C(=O)O)o5)c(=O)n42)c2ccccc2CC3)cc1]

90. The method of any one of claims 86-88, wherein the 1,3-thiazolidin-4-one has a structure:

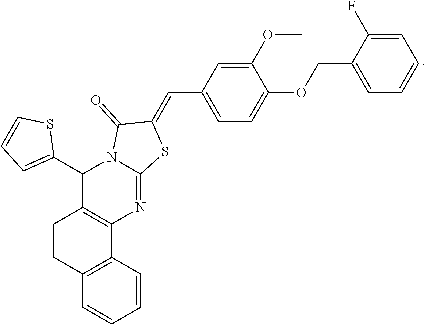 [SMILES: COc1cc(/C=c2\sc3n(c2=O)C(c2cccs2)C2=C(N=3)c3ccccc3CC2)ccc1OCc1ccccc1F]

91. The method of any one of claims 86-88, wherein the 1,3-thiazolidin-4-one has a structure:

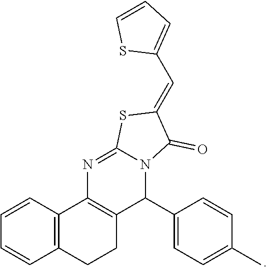 [SMILES: Cc1ccc(C2C3=C(N=c4s/c(=C\c5cccs5)c(=O)n42)c2ccccc2CC3)cc1]

92. The method of any one of claims 86-88, wherein the 1,3-thiazolidin-4-one has a structure:

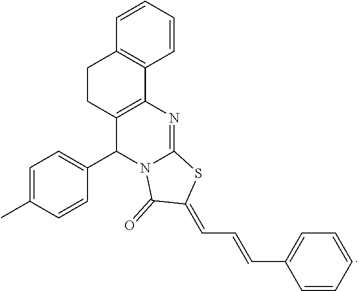 [SMILES: Cc1ccc(C2C3=C(N=c4s/c(=C\C=C\c5ccccc5)c(=O)n42)c2ccccc2CC3)cc1]

93. The method of claim 86, wherein the (forms a 5-member 1,2,4-triazole ring.

94. The method of any one of claims 86 or 93, wherein the 1,3-thiazolidin-4-one has a structure: 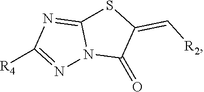
wherein R₄ is selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

95. The method of any one of claims 86, 93, or 94, wherein the 1,3-thiazolidin-4-one has a structure:

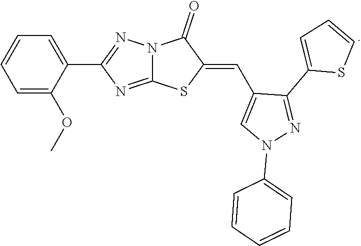 [SMILES: COc1ccccc1-c1nc2s/c(=C\c3cn(-c4ccccc4)nc3-c3cccs3)c(=O)n2n1]

96. The method of any one of claims 86, 93, or 94, wherein the 1,3-thiazolidin-4-one has a structure:

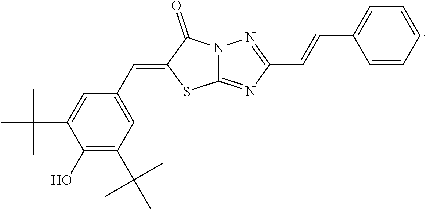 [SMILES: CC(C)(C)c1cc(/C=c2\sc3nc(/C=C/c4ccccc4)nn3c2=O)cc(C(C)(C)C)c1O]

97. The method of claim 86, wherein the (forms a 6-member 1,2,4-triazine ring.

98. The method of any one of claims 86 or 97, wherein the 1,3-thiazolidin-4-one has a structure: 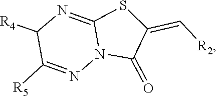
wherein R₄ is connected to R₅ to form a 5- or 6-member ring, or R₄ and R₅ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

99. The method of any one of claims 86, 97, or 98, wherein the 1,3-thiazolidin-4-one has a structure:

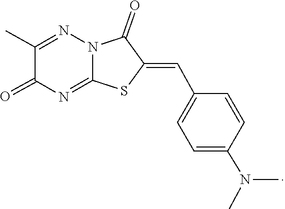 [SMILES: Cc1nn2c(=O)/c(=C/c3ccc(N(C)C)cc3)sc2nc1=O]

100. The method of claim 86, wherein the (forms a 5-member imidazole ring.

101. The method of any one of claims 86 or 100, wherein the 1,3-thiazolidin-4-one has a structure: 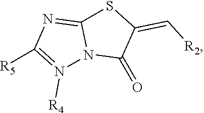
wherein R₄ is connected to R₅ to form a 5- or 6-member ring, or R₄ and R₅ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

102. The method of any one of claims 86, 100, or 101, wherein the 1,3-thiazolidin-4-one has a structure:

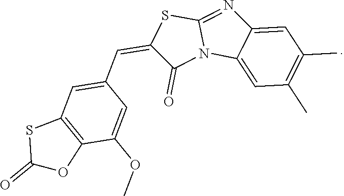 [SMILES: COc1cc(/C=c2/sc3nc4cc(C)c(C)cc4n3c2=O)cc2sc(=O)oc12]

103. The method of any one of claims 86, 100, or 101, wherein the 1,3-thiazolidin-4-one has a structure:

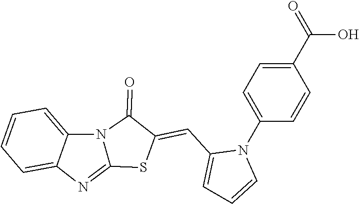 [SMILES: O=C(O)c1ccc(-n2cccc2/C=c2\sc3nc4ccccc4n3c2=O)cc1]

104. The method of any one of claims 76-85, wherein the 1,3-thiazolidin-4-one has a structure: 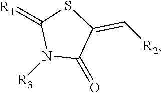
wherein R₂ is a moiety conjugated to the 1,3-thiazolidin-4-one, and R₁ and R₃ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

105. The method of any one of claims 76-104, wherein the 1,3-thiazolidin-4-one is selected from FIGS. 1-10.

106. The method of any one of claims 76-104, wherein the 1,3-thiazolidin-4-one is selected from the group consisting of the following compounds, each identified by a first hash block of an InChIKey representation of the compound: GDXGBMCZOXRFKZ, XXIFJCDGHHYVPY, LLBDQTJSFGCSPA, CSECDVGKMRYMBA, UVIADTPRGFRVCM, DQAQKCHKVDDCMJ, VRQNFRXLZRUERN, ORTJLPOPOPUFRQ, ZCUIUJKARNDPTG, GEIPYTMFCOHNML, XJGSASDSJVGEAM, JYSSCLBGNGYLCY, VEEKQWLHUGCTRP, GMKPMJXUVHHDQP, IMCGPNYNTRSEMV, VAJWZMLWGMPCPJ, STERAJHUBHMKQR, YGFSWKOFIXLTBF, SSSPGZVARDGPHM, FANSALUVCYCILX, VCQVWNLLJWSMAE, LKQRSZHTPZVPAL, NPZNGQQPODKLTI, XJTHNGWBKGBKEO, LBFUDEINNFVSMR, CYMVHYPALLLXLR, JKZJUMPZQUBSAU, FOLRGFOSKQMNJG, WRICLGGWAGWBKH, USWWPLGFGAIIKE, DJJOELKJJQAYDO, UKXHUYWQFPEWKG, QNAIVJUTJSTUNI, ZNYSASNHOUVTBF, LUUZBEJCHIUJKJ, GUFWJTGLPMGXQE, DVEKMTJFDHKZFF, ACLBCFOKYXZACK, KQGXPZFAOYUQTF, MYFQAWLHGKZQKW, HXOCPGIYIYTYSP, DJJOEJKBWSOWNI, ZOERYULNAXYLNR, FWYWFSSNMVHQSO, XNGPPWGMEAMBFQ, LITFCYUSYZURBF, CNQGRWMBPZAIOD, UHLMZBCHPPRZJG, DONQABNWUIKJPQ, VJZHEGUWNYNVTC, OQGQFPFOAKPLNS, and ZATSGJMKCAPLAC.

107. The method of any one of claims 76-104, wherein the 1,3-thiazolidin-4-one is selected from the group consisting of the following compounds, each identified by a first hash block of an InChIKey representation of the compound: FWYWFSSNMVHQSO, XNGPPWGMEAMBFQ, LITFCYUSYZURBF, CNQGRWMBPZAIOD, UHLMZBCHPPRZJG, DONQABNWUIKJPQ, VJZHEGUWNYNVTC, OQGQFPFOAKPLNS, ZATSGJMKCAPLAC, and GDXGBMCZOXRFKZ.

108. A colorant for use in coloring a material, comprising a 1,3-thiazolidin-4-one.

109. The colorant of claim 108, wherein the colorant is a pigment.

110. The colorant of claim 108, wherein the colorant is a dye.

111. The colorant of any one of claims 108-110, wherein the colorant is contained within a paint.

112. The colorant of any one of claims 108-110, wherein the colorant is contained within an ink.

113. The colorant of any one of claims 108-110, wherein the colorant is contained within a paste.

114. The colorant of any one of claims 108-110, wherein the colorant is contained within a lacquer.

115. The colorant of any one of claims 108-110, wherein the colorant is contained within a polymer resin.

116. The colorant of any one of claims 108-110, wherein the colorant is contained within a plastic.

117. The colorant of any one of claims 108-110, wherein the colorant is contained within a melt.

118. The colorant of any one of claims 108-117, wherein the 1,3-thiazolidin-4-one has a structure: 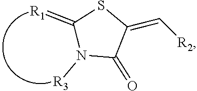
wherein R₂ is a moiety conjugated to the 1,3-thiazolidin-4-one, and R₁ and R₃ are connected via (to form a 5- or 6-member ring.

119. The colorant of claim 118, wherein the (forms a 6-member pyrimidine ring.

120. The colorant of any one of claims 118 or 119, wherein the 1,3-thiazolidin-4-one has a structure: 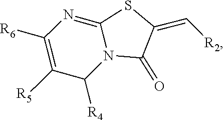
wherein R₅ is connected to one of R₄ or R₆ to form a 5- or 6-member ring, and the other of R₄ or R₆ is selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

121. The colorant of any one of claims 118-120, wherein the 1,3-thiazolidin-4-one has a structure:

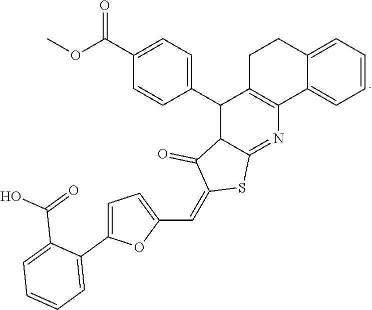 [SMILES: COC(=O)c1ccc(C2C3=C(N=C4S/C(=C/c5ccc(-c6ccccc6C(=O)O)o5)C(=O)C42)c2ccccc2CC3)cc1]

122. The colorant of any one of claims 118-120, wherein the 1,3-thiazolidin-4-one has a structure:

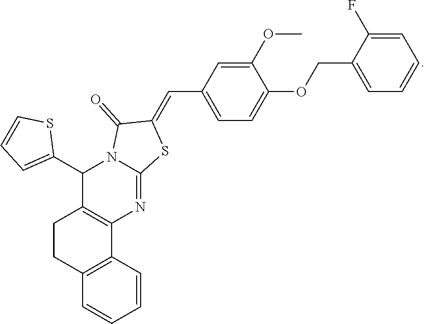 [SMILES: COc1cc(/C=c2\sc3n(c2=O)C(c2cccs2)C2=C(N=3)c3ccccc3CC2)ccc1OCc1ccccc1F]

123. The colorant of claim any one of claims 118-120, wherein the 1,3-thiazolidin-4-one has a structure:

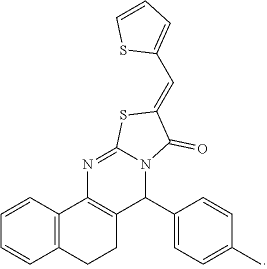 [SMILES: Cc1ccc(C2C3=C(N=c4s/c(=C\c5cccs5)c(=O)n42)c2ccccc2CC3)cc1]

124. The colorant of claim any one of claims 118-120, wherein the 1,3-thiazolidin-4-one has a structure:

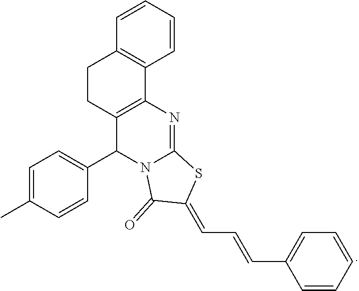 [SMILES: Cc1ccc(C2C3=C(N=c4s/c(=C\C=C\c5ccccc5)c(=O)n42)c2ccccc2CC3)cc1]

125. The colorant of claim 118, wherein the (forms a 5-member 1,2,4-triazole ring.

126. The colorant of any one of claims 118 or 125, wherein the 1,3-thiazolidin-4-one has a structure: 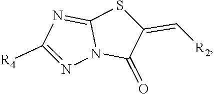
wherein R₄ is selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

127. The colorant of any one of claims 118, 125, or 126, wherein the 1,3-thiazolidin-4-one has a structure:

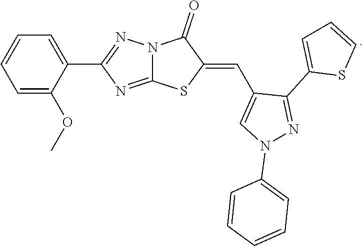 [SMILES: COc1ccccc1-c1nc2s/c(=C\c3cn(-c4ccccc4)nc3-c3cccs3)c(=O)n2n1]

128. The colorant of any one of claims 118, 125, or 126, wherein the 1,3-thiazolidin-4-one has a structure:

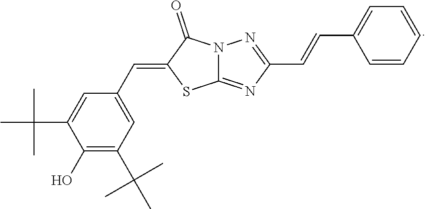 [SMILES: CC(C)(C)c1cc(/C=c2\sc3nc(/C=C/c4ccccc4)nn3c2=O)cc(C(C)(C)C)c1O]

129. The colorant of claim 118, wherein the (forms a 6-member 1,2,4-triazine ring.

130. The colorant of any one of claims 118 or 129, wherein the 1,3-thiazolidin-4-one has a structure: 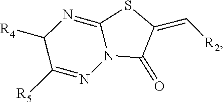
wherein R₄ is connected to R₅ to form a 5- or 6-member ring, or R₄ and R₅ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

131. The colorant of any one of claims 118, 129, or 130, wherein the 1,3-thiazolidin-4-one has a structure:

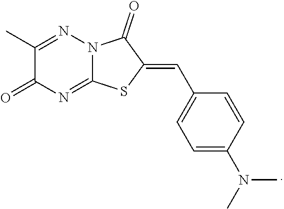

132. The colorant of claim 118, wherein the (forms a 5-member imidazole ring.

133. The colorant of any one of claims 118 or 132, wherein the 1,3-thiazolidin-4-one has a structure: 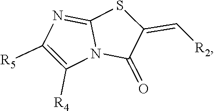
wherein R₄ is connected to R₅ to form a 5- or 6-member ring, or R₄ and R₅ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

134. The colorant of any one of claims 118, 132, or 133, wherein the 1,3-thiazolidin-4-one has a structure:

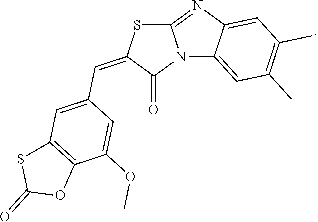 [SMILES: COc1cc(/C=c2/sc3nc4cc(C)c(C)cc4n3c2=O)cc2sc(=O)oc12]

135. The colorant of any one of claims 118, 132, or 133, wherein the 1,3-thiazolidin-4-one has a structure:

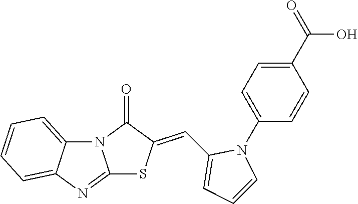 [SMILES: O=C(O)c1ccc(-n2cccc2/C=c2\sc3nc4ccccc4n3c2=O)cc1]

136. The colorant of any one of claims 108-117, wherein the 1,3-thiazolidin-4-one has a structure: 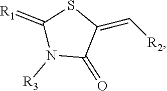
wherein R₂ is a moiety conjugated to the 1,3-thiazolidin-4-one, and R₁ and R₃ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

137. The colorant of any one of claims 108-136, wherein the 1,3-thiazolidin-4-one is selected from FIGS. 1-10.

138. The colorant of any one of claims 108-136, wherein the 1,3-thiazolidin-4-one is selected from the group consisting of the following compounds, each identified by a first hash block of an InChIKey representation of the compound:
GDXGBMCZOXRFKZ,
XXIFJCDGHHYVPY,
LLBDQTJSFGCSPA,
CSECDVGKMRYMBA,
UVIADTPRGFRVCM,
DQAQKCHKVDDCMJ,
VRQNFRXLZRUERN,
ORTJLPOPOPUFRQ,
ZCUIUJKARNDPTG,
GEIPYTMFCOHNML,
XJGSASDSJVGEAM,
JYSSCLBGNGYLCY,
VEEKQWLHUGCTRP,
GMKPMJXUVHHDQP,
IMCGPNYNTRSEMV,
VAJWZMLWGMPCPJ,
STERAJHUBHMKQR,
YGFSWKOFIXLTBF,
SSSPGZVARDGPHM,
FANSALUVCYCILX,
VCQVWNLLJWSMAE,
LKQRSZHTPZVPAL,
NPZNGQQPODKLTI,
XJTHNGWBKGBKEO,
LBFUDEINNFVSMR,
CYMVHYPALLLXLR,
JKZJUMPZQUBSAU,
FOLRGFOSKQMNJG,
WRICLGGWAGWBKH,
USWWPLGFGAIIKE,
DJJOELKJJQAYDO,
UKXHUYWQFPEWKG,
QNAIVJUTJSTUNI,
ZNYSASNHOUVTBF,
LUUZBEJCHIUJKJ,
GUFWJTGLPMGXQE,
DVEKMTJFDHKZFF,
ACLBCFOKYXZACK,
KQGXPZFAOYUQTF,
MYFQAWLHGKZQKW,
HXOCPGIYIYTYSP,
DJJOEJKBWSOWNI,
ZOERYULNAXYLNR,
FWYWFSSNMVHQSO,
XNGPPWGMEAMBFQ,
LITFCYUSYZURBF,
CNQGRWMBPZAIOD,
UHLMZBCHPPRZJG,
DONQABNWUIKJPQ,
VJZHEGUWNYNVTC,
OQGQFPFOAKPLNS,
and
ZATSGJMKCAPLAC.

139. A method, comprising:
embedding a colorant comprising a 1,3-thiazolidin-4-one in an article.

140. The method of claim 139, wherein the colorant is a pigment.

141. The method of claim 139, wherein the colorant is a dye.

142. The method of any one of claims 139-141, wherein the colorant is contained within a paint.

143. The method of any one of claims 139-141, wherein the colorant is contained within an ink.

144. The method of any one of claims 139-141, wherein the colorant is contained within a paste.

145. The method of any one of claims 139-141, wherein the colorant is contained within a lacquer.

146. The method of any one of claims 139-141, wherein the colorant is contained within a polymer resin.

147. The method of any one of claims 139-141, wherein the colorant is contained within a plastic.

148. The method of any one of claims 139-141, wherein the colorant is contained within a melt.

149. The method of any one of claims 139-148, wherein the 1,3-thiazolidin-4-one has a structure: 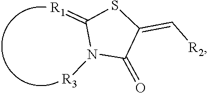
wherein R₂ is a moiety conjugated to the 1,3-thiazolidin-4-one, and R₁ and R₃ are connected via (to form a 5- or 6-member ring.

150. The method of claim 149, wherein the (forms a 6-member pyrimidine ring.

151. The method of any one of claims 149 or 150, wherein the 1,3-thiazolidin-4-one has a structure: 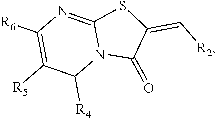
wherein R₅ is connected to one of R₄ or R₆ to form a 5- or 6-member ring, and the other of R₄ or R₆ is selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

152. The method of any one of claims 149-151, wherein the 1,3-thiazolidin-4-one has a structure:

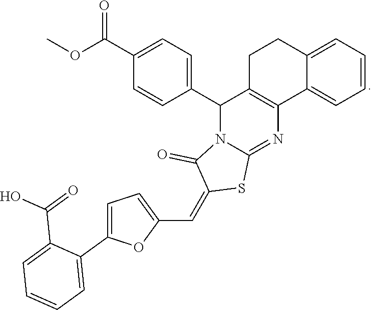 [SMILES: COC(=O)c1ccc(C2C3=C(N=c4s/c(=C/c5ccc(-c6ccccc6C(=O)O)o5)c(=O)n42)c2ccccc2CC3)cc1]

153. The method of any one of claims 149-151, wherein the 1,3-thiazolidin-4-one has a structure:

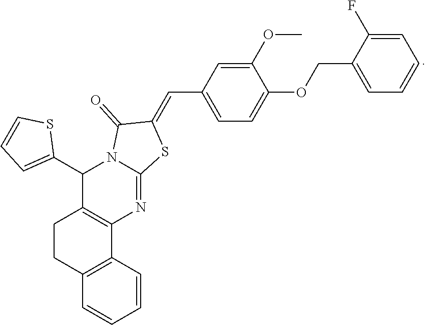 [SMILES: COc1cc(/C=c2\sc3n(c2=O)C(c2cccs2)C2=C(N=3)c3ccccc3CC2)ccc1OCc1ccccc1F]

154. The method of any one of claims 149-151, wherein the 1,3-thiazolidin-4-one has a structure:

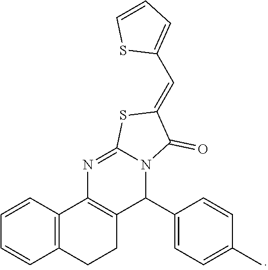 [SMILES: Cc1ccc(C2C3=C(N=c4s/c(=C\c5cccs5)c(=O)n42)c2ccccc2CC3)cc1]

155. The method of any one of claims 149-151, wherein the 1,3-thiazolidin-4-one has a structure:

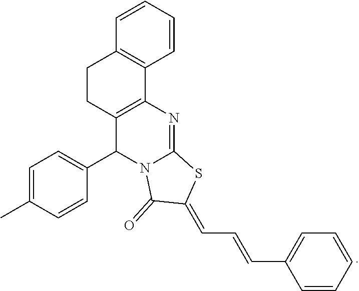 [SMILES: Cc1ccc(C2C3=C(N=c4s/c(=C\C=C\c5ccccc5)c(=O)n42)c2ccccc2CC3)cc1]

156. The method of claim 149, wherein the (forms a 5-member 1,2,4-triazole ring.

157. The method of any one of claims 149 or 156, wherein the 1,3-thiazolidin-4-one has a structure: 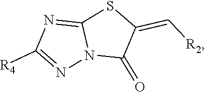
wherein R₄ is selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

158. The method of any one of claims 149, 156, or 157, wherein the 1,3-thiazolidin-4-one has a structure:

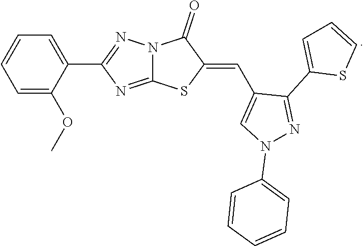 [SMILES: COc1ccccc1-c1nc2s/c(=C\c3cn(-c4ccccc4)nc3-c3cccs3)c(=O)n2n1]

159. The method of any one of claims 149, 156, or 157, wherein the 1,3-thiazolidin-4-one has a structure:

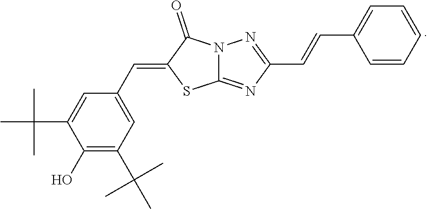 [SMILES: CC(C)(C)c1cc(/C=c2\sc3nc(/C=C/c4ccccc4)nn3c2=O)cc(C(C)(C)C)c1O]

160. The method of claim 149, wherein the (forms a 6-member 1,2,4-triazine ring.

161. The method of any one of claims 149 or 160, wherein the 1,3-thiazolidin-4-one has a structure: 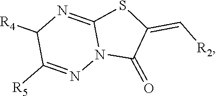
wherein R₄ is connected to R₅ to form a 5- or 6-member ring, or R₄ and R₅ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

162. The method of any one of claims 149, 160, or 161, wherein the 1,3-thiazolidin-4-one has a structure:

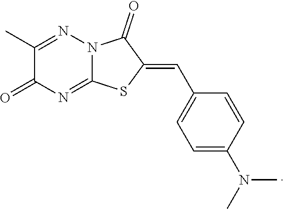

163. The method of claim 149, wherein the (forms a 5-member imidazole ring.

164. The method of any one of claims 149 or 163, wherein the 1,3-thiazolidin-4-one has a structure: 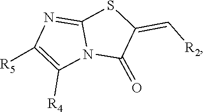
wherein R₄ is connected to R₅ to form a 5- or 6-member ring, or R₄ and R₅ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

165. The method of any one of claims 149, 163, or 164, wherein the 1,3-thiazolidin-4-one has a structure:

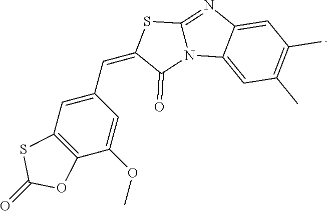 [SMILES: COc1cc(/C=c2/sc3nc4cc(C)c(C)cc4n3c2=O)cc2sc(=O)oc12]

166. The method of any one of claims 149, 163, or 164, wherein the 1,3-thiazolidin-4-one has a structure:

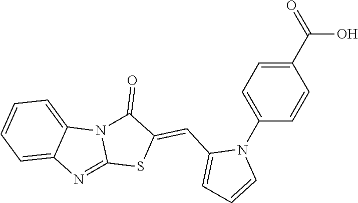 [SMILES: O=C(O)c1ccc(-n2cccc2/C=c2\sc3nc4ccccc4n3c2=O)cc1]

167. The method of any one of claims 139-148, wherein the 1,3-thiazolidin-4-one has a structure: 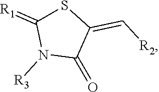
wherein R₂ is a moiety conjugated to the 1,3-thiazolidin-4-one, and R₁ and R₃ are each independently selected from the group consisting of —H, an alkyl, a cycloalkyl, an aromatic, a heterocyclic, an imidazolyl, a pyridyl, a pyrazinyl, a pyrimidinyl, a piperidinyl, a pyrazolyl, a hydroxyl, an alkoxy, an amine, an alkylamine, a dialkylamine, an arylamine, an amide, an N-substituted amide, an alkyl sulfonyl, a ketone, a sulfonamide, a nitrile, a nitro, a halogen, a trifluoromethyl, a trichloromethyl, a tribromomethyl, or an acyl.

168. The method of any one of claims 139-167, wherein the 1,3-thiazolidin-4-one is selected from FIGS. 1-10.

169. The method of any one of claims 139-167, wherein the 1,3-thiazolidin-4-one is selected from the group consisting of the following compounds, each identified by a first hash block of an InChIKey representation of the compound:
GDXGBMCZOXRFKZ,
XXIFJCDGHHYVPY,
LLBDQTJSFGCSPA,
CSECDVGKMRYMBA,
UVIADTPRGFRVCM,
DQAQKCHKVDDCMJ,
VRQNFRXLZRUERN,
ORTJLPOPOPUFRQ,
ZCUIUJKARNDPTG,
GEIPYTMFCOHNML,
XJGSASDSJVGEAM,
JYSSCLBGNGYLCY,
VEEKQWLHUGCTRP,
GMKPMJXUVHHDQP,
IMCGPNYNTRSEMV,
VAJWZMLWGMPCPJ,
STERAJHUBHMKQR,
YGFSWKOFIXLTBF,
SSSPGZVARDGPHM,
FANSALUVCYCILX,
VCQVWNLLJWSMAE,
LKQRSZHTPZVPAL,
NPZNGQQPODKLTI,
XJTHNGWBKGBKEO,
LBFUDEINNFVSMR,
CYMVHYPALLLXLR,
JKZJUMPZQUBSAU,
FOLRGFOSKQMNJG,
WRICLGGWAGWBKH,
USWWPLGFGAIIKE,
DJJOELKJJQAYDO,
UKXHUYWQFPEWKG,
QNAIVJUTJSTUNI,
ZNYSASNHOUVTBF,
LUUZBEJCHIUJKJ,
GUFWJTGLPMGXQE,
DVEKMTJFDHKZFF,
ACLBCFOKYXZACK,
KQGXPZFAOYUQTF,
MYFQAWLHGKZQKW,
HXOCPGIYIYTYSP,
DJJOEJKBWSOWNI,
ZOERYULNAXYLNR,
FWYWFSSNMVHQSO,
XNGPPWGMEAMBFQ,
LITFCYUSYZURBF,
CNQGRWMBPZAIOD,
UHLMZBCHPPRZJG,
DONQABNWUIKJPQ,
VJZHEGUWNYNVTC,
OQGQFPFOAKPLNS,
and
ZATSGJMKCAPLAC.
